(19) United States
(12) Patent Application Publication
(10) Pub. No.: US 2026/0245930 A1
(43) Pub. Date: Aug. 20, 2026

(54) METHOD AND USE FOR CONDITIONING FUEL CELLS

(71) Applicant: Simon Fraser University, Burnaby (CA)

(72) Inventors: Steven HOLDCROFT, Burnaby (CA); Subash RAJASEKAR, Burnaby (CA); Emmanuel Olansile BALOGUN, Burnaby (CA)

(21) Appl. No.: 19/470,658

(22) PCT Filed: Mar. 28, 2024
(86) PCT No.: PCT/CA2024/050411

§ 371 Date: Sep. 29, 2025

Related U.S. Application Data
(60) Provisional application No. 63/455,958, filed on Mar. 30, 2023.

(51) Int. Cl. H01M 8/04223; H01M 8/0432; H01M 8/04537; H01M 8/10; H01M 8/1004

(52) U.S. Cl. CPC H01M 8/04231; H01M 8/0432; H01M 8/04552; H01M 8/04582; H01M 8/04611; H01M 8/1004; H01M 2008/1095

(57) ABSTRACT

A method of conditioning a fuel cell having a membrane electrode assembly (MEA) as well as associated use and fuel cell. The MEA comprises a hydrocarbon-based ionomer catalyst layer. The conditioning process include reducing the oxidant supplied to the cathode side of the MEA either via oxygen cutoff and/or via inert gas purging, while maintaining a current or voltage generated by the fuel cell until either a time condition or a voltage condition is met. The conditioning process according to aspects of the present disclosure is advantageous not only because it provides a solution for the type of MEA that is difficult to condition using conventional approaches, but also because it can activate this type of MEA in an exceptionally short time and at large scale, and allows automated operation to mitigate against human error, both of which can significantly reduce fuel cell manufacturing/operating costs.

### TECHNICAL FIELD

The present disclosure is directed to a method for conditioning a fuel cell, and in particular to a method for conditioning a membrane electrode assembly (MEA) of a fuel cell, and to the use of the method for conditioning an MEA of a fuel cell containing a hydrocarbon-based catalyst layer.

### BACKGROUND

As the global demand for clean, carbon neutral, sustainable and renewable energy continues to grow, there is an increased focus on hydrogen as an energy carrier. Hydrogen fuel cells are electrochemical energy storage devices that convert the chemical energy stored in hydrogen into electricity through an electrochemical reaction. Among the various types of fuel cells, proton exchange membrane (PEM) fuel cells or PEMFCs are widely used due to their robustness, high energy conversion efficiency, low operating temperature, compactness, high power and energy density.

Typically, the MEA of a PEMFC comprises a PEM sandwiched between anode and cathode catalyst layers. A catalyst layer is typically deposited from a mixture of catalyst, solvent, and a proton conducting ionomer. The ionomer is used both in the catalyst layers and for the PEM in a PEMFC. In the catalyst layer, the ionomer acts as a binder that holds the catalyst particles in place and provides a pathway for the transport of reactants and products to and from the catalyst surface. The ionomer also facilitates the transfer of protons between the catalyst particles and the PEM. In the PEM, the ionomer acts as a proton exchange medium, allowing protons to move through the membrane while blocking the passage of electrons. In principle, the ionomer should be selected to ensure that it has the appropriate proton conductivity and chemical stability under the operating conditions of the fuel cell. Known examples of ionomers include a perfluorosulfonic acid (PFSA) ionomer, such as Nafion® and Aquivion®, which exhibit high proton conductivity and mechanical and chemical robustness.

While PFSA ionomers feature good proton conductivity and durability, they have several drawbacks, including high gas permeability, high production costs, and the use of potentially environmentally hazardous chemical feedstocks that complicate the synthetic processes for their manufacture. Further, PFSA ionomers have a limited operating temperature range, typically between 80° C. and 100° C., which can limit their use in high-temperature applications. PFSA ionomers also require careful water management to maintain performance-excessive water can reduce their proton conductivity, while insufficient water can cause membrane desiccation and reduce durability. In addition, PFSA ionomers are made from perfluorinated compounds, which are not biodegradable and have potential environmental and health impacts.

To address the limitations of PFSA ionomers, fluorine-free hydrocarbon-based solid polymer electrolytes are being explored as alternatives for PEMFCs, with their simpler and more versatile synthesis, reduced gas permeability, and potentially lower cost. Hydrocarbon-based ionomers are typically less expensive than PFSA ionomers, which can reduce the overall cost of the fuel cell system. In addition, hydrocarbon-based ionomers have a wider operating temperature range than PFSA ionomers, typically between 100° C. and 200° C., which can make them suitable for high-temperature applications. They are also less sensitive to water content than PFSA ionomers, which can simplify water management requirements and reduce the risk of membrane desiccation. In addition, hydrocarbon-based ionomers are made from non-fluorinated, non-toxic materials that are more environmentally friendly than PFSA ionomers.

### SUMMARY

According to a first aspect, there is provided a method for conditioning a fuel cell comprising a membrane electrode assembly (MEA) with at least one hydrocarbon-based ionomer catalyst layer, the method comprising: supplying hydrogen to an anode side of the MEA and oxidant to a cathode side of the MEA; purging the oxidant supplied to the cathode side of the MEA with an inert gas, wherein the inert gas is chemically inert relative to hydrogen; and applying a voltage scan profile across the MEA beginning at an open circuit voltage (OCV) and ending at a cycle end voltage lower than the OCV.

In some embodiments, the MEA may comprise a proton exchange membrane composed of hydrocarbon-based or perfluorosulfonic acid (PFSA) material.

In some embodiments, the applying may be performed after the inert gas has purged the oxidant.

In some embodiments, the replacement of the oxidant with the inert gas may be performed during the applying.

In some embodiments, the voltage scan profile may begin by maintaining the voltage across the MEA at the OCV for an initial duration.

In some embodiments, the initial duration may range from 1 second to 30 minutes.

In some embodiments, the voltage scan profile may comprise a voltage decrease duration in which the voltage across the MEA decreases at a rate ranging from 1 mV/s to 1 V/s.

In some embodiments, the voltage decrease duration may be performed after the oxidant has been purged by the inert gas.

In some embodiments, the cycle end voltage may be between 1 mV and 1 V.

In some embodiments, the method may further comprise resupplying the oxidant to the cathode side after reaching the cycle end voltage.

In some embodiments, the method may further comprise repeating the replacing, applying, and resupplying for a plurality of cycles until a difference in power density between two successive cycles is less than a cutoff value.

In some embodiments, the cutoff value may range from 20 to 30 mW/cm².

In some embodiments, the method may further comprise repeating the replacing, applying, and resupplying for a predetermined number of cycles.

In some embodiments, the hydrogen may be supplied at 0.1 to 5.0 standard liters per minute (SLPM) on the anode side of the MEA and the oxidant may be supplied at 0.1 to 5.0 SLPM on the cathode side of the MEA.

In some embodiments, the fuel cell may be conditioned at a temperature of 60 to 90° C. and a relative humidity at 70% to 100% on the anode and cathode sides of the MEA.

In some embodiments, the inert gas may comprise at least one of nitrogen, argon, or helium.

According to a second aspect, there is provided a method for conditioning a fuel cell comprising an MEA with at least one hydrocarbon-based ionomer catalyst layer, the method comprising: supplying hydrogen to an anode side of the MEA and oxidant to a cathode side of the MEA to generate an electric current; adjusting a voltage of the electric current from an open circuit voltage (OCV) to a first voltage and maintaining the first voltage for a selected first duration; and reducing the oxidant supplied to the cathode side of the MEA while maintaining a constant current until either a cutoff duration or a cutoff voltage is met.

According to a third aspect, there is provided a method for conditioning a fuel cell comprising an MEA with at least one hydrocarbon-based ionomer catalyst layer, the method comprising: supplying hydrogen to an anode side of the MEA and oxidant to a cathode side of the MEA; adjusting a voltage across the MEA from an open circuit voltage (OCV) to a first voltage and maintaining the first voltage for a selected first duration; and reducing the oxidant supplied to the cathode side of the MEA while maintaining a constant current until either a cutoff duration or a cutoff voltage is met.

In some embodiments, the MEA may comprise a proton exchange membrane composed of hydrocarbon-based or perfluorosulfonic acid (PFSA) material.

In some embodiments, the method may further comprise, prior to the adjusting, increasing a back pressure on the anode side of the MEA to a first pressure level and maintaining a back pressure on the cathode side of the MEA at an ambient pressure, wherein the first pressure is larger than the ambient pressure.

In some embodiments, the method may further comprise, prior to the adjusting, holding the voltage across the MEA at the OCV for a selected second duration.

In some embodiments, the method may further comprise, prior to the adjusting, holding the voltage of the electric current at the OCV for a selected second duration.

In some embodiments, the method may further comprise repeating the adjusting and the reducing for a plurality of cycles until a voltage difference between a voltage response on a load after the selected first duration of a current cycle and the voltage response on the load after the selected first duration of a previous cycle is less than a voltage threshold.

In some embodiments, the first pressure level may range from 22 to 44 psi.

In some embodiments, the first voltage may range from 0.3 to 0.8 V.

In some embodiments, the constant current may range from 0.2 to 10.0 A.

In some embodiments, the selected second duration may range from 1 to 15 minutes.

In some embodiments, the selected first duration may range from 3 to 30 minutes.

In some embodiments, the cutoff voltage may range from 0.1 to 0.5 V.

In some embodiments, the voltage threshold may range from 2 to 20 mV.

In some embodiments, the hydrogen may be supplied at 0.1 to 5.0 standard liters per minute (SLPM) on the anode side of the MEA and the oxidant may be supplied at 0.1 to 5.0 SLPM on the cathode side of the MEA.

In some embodiments, the fuel cell may be conditioned at a temperature of 60 to 90° C. and a relative humidity at 70% to 100% on the anode and cathode sides of the MEA.

According to a fourth aspect, there is provided use of the method as described herein for conditioning a fuel cell having an MEA, wherein the MEA comprises a hydrocarbon-based ionomer catalyst layer.

According to a fifth aspect, there is provided a proton exchange membrane fuel cell comprising an MEA with at least one hydrocarbon-based ionomer catalyst layer, wherein the fuel cell is conditioned by the method as described herein.

With the above aspects of the present disclosure, an advantageous conditioning process has been achieved for MEAs with hydrocarbon-based catalyst binders, regardless of the type of PEM it contains, to improve the initial performance and durability of MEAs used in fuel cells. This conditioning process is advantageous not only because it provides a solution for the type of MEA that is difficult to condition using conventional approaches, but also because it can activate this type of MEA in an exceptionally short time and allows automated operation to mitigate against human error, both of which can significantly reduce manufacturing costs.

This summary does not necessarily describe the full scope of all aspects. Other aspects, features and advantages will become apparent to those of ordinary skill in the art upon review of the following description of specific embodiments.

### BRIEF DESCRIPTION OF THE DRAWINGS

In the accompanying drawings, which illustrate one or more exemplary embodiments:

FIG. 1 is a schematic of an MEA structure of a PEMFC according to one embodiment of the present disclosure.

FIG. 2 is a flow chart of steps in a method for conditioning the MEA structure depicted in FIG. 1.

FIG. 3 are four plots each showing the power density and current density as a function of conditioning time for MEAs conditioned by different conditioning techniques: (A) amperometric conditioning; (B) European Union (EU) conditioning; (C) Department of Energy (DOE) conditioning; and (D) cathode starvation conditioning according to one embodiment of the present disclosure. The conditioned MEAs include a hydrocarbon-based PEM and hydrocarbon-based ionomers within catalyst layers, with Pt loadings of 0.4 mg_{Pt}/cm² for both cathode and anode.

FIG. 4 shows performance plots of MEAs containing a hydrocarbon-based PEM and hydrocarbon-based ionomers within catalyst layers subjected to the four conditioning processes shown in FIG. 3: (A) polarization and power curves immediately after conditioning; (B) peak power density at 0.6 V; (C) Nyquist plots obtained from Electrochemical Impedance Spectroscopy (EIS) spectra recorded at 0.8 V under the H₂/O₂ configuration; (D) Electrochemical Surface Area (ECSA) Pt loadings of 0.4 mg_{Pt}/cm² for cathode and anode under the H₂/N₂ configuration; (E) relationship between ECSA (m²·gₚₜ⁻¹) and charge transfer resistance (mΩ·cm²); (F) EIS plot illustrating the high-frequency intercept and low-frequency intercept by a linear fit of the low-frequency data to determine the ionic resistance of the catalyst layer of the MEAs under the H₂/N₂ configuration; (G) capacitance plots obtained from the EIS measurements of the catalyst ionic resistance; and (H) time taken to condition each of the MEAs.

FIG. 5 shows I-V polarization and power density plots of MEAs containing a hydrocarbon-based PEM and hydrocarbon-based ionomers within catalyst layers subjected to the four conditioning processes shown in FIG. 3: (A) after 3,000 degradation cycles; (B) after 6,000 degradation cycles; (C) after 9,000 degradation cycles; (D) graph showing the corresponding peak power density plots of MEAs before and after each degradation cycle; and (E) percent power loss comparing the peak power density immediately after conditioning and after 9,000 degradation cycles.

FIG. 6 shows plots of a linear sweep voltametric analysis of MEAs containing a hydrocarbon-based PEM and hydrocarbon-based ionomers within catalyst layers: (A) immediately after conditioning; (B) after 3,000 degradation cycles; (C) after 6,000 degradation cycles; and (D) after 9,000 degradation cycles.

FIG. 7 shows the comparison of Nyquist plots with EIS spectra recorded in a configuration of H₂ anode and O₂ cathode: (A) after 3,000 degradation cycles; (B) after 6,000 degradation cycles; (C) after 9,000 degradation cycles; as well as the comparison of Nyquist plots, illustrating the high-frequency intercept and low-frequency intercept by linearly fitting low-frequency data to determine the ionic resistance of the catalyst layer, in a configuration of H₂ anode and N₂ cathode: (D) after 3,000 degradation cycles; (E) after 6,000 degradation cycles; and (F) after 9,000 degradation cycles.

FIG. 8 shows plots of the power density and current density as a function of conditioning time for MEAs conditioned by different conditioning techniques: (A) amperometric conditioning; (B) EU conditioning; (C) DOE conditioning; (D) cathode starvation conditioning according to one embodiment of the present disclosure. The conditioned MEAs include a hydrocarbon-based PEM and PFSA-based ionomers within catalyst layers. Pt loadings were 0.4 mg_{Pt}/cm² for both cathode and anode.

FIG. 9 shows performance plots of MEAs containing a hydrocarbon-based PEM and PFSA-based ionomers within catalyst layers subjected to the four conditioning processes shown in FIG. 8: (A) polarization and power curves immediately after conditioning; (B) polarization and power curves after 9,000 degradation cycles; (C) performance data with error bars showing the maximum power density of the MEAs conditioned by the four conditioning protocols after conditioning and after 3,000, 6,000, and 9,000 degradation cycles; (D) time taken to condition each of the MEAs.

FIG. 10 shows the power density and current density as a function of conditioning time for cathode starvation conditioned for MEAs containing a PFSA-based PEM and hydrocarbon-based ionomers within catalyst layers according to one embodiment of the present disclosure.

FIG. 11 shows polarization and power curve profile of MEAs containing a PFSA-based PEM and hydrocarbon-based ionomers within catalyst layers under the conditions of 80° C., 100% RH, 1 atm pressure, H₂ anode, and O₂ cathode.

FIGS. 12A and 12B show two example voltage scan profiles for an inert gas purging conditioning method according to an embodiment described herein.

FIGS. 13A to 13F show six example voltage scan profiles for an inert gas purging conditioning method according to an embodiment described herein.

FIG. 14A shows the voltage profile of the HC/HC/HC based PEMFC during nitrogen purging conditioning.

FIG. 14B shows corresponding power density values indicating an improvement in power density after each conditioning cycle through the nitrogen purging conditioning of FIG. 14A.

FIG. 15 shows an EIS Nyquist plot of the HC/HC/HC based PEMFC measured at 0.8 V before and after nitrogen purging conditioning, depicting the decrease in MEA resistance and charge transfer resistance after conditioning.

FIG. 16 shows power density graphs of oxygen cutoff conditioning followed by nitrogen purging conditioning.

FIG. 17 shows a PEMFC I-V graph of MEA containing the HC/HC/HC configuration conditioned sequentially by DOE conditioning for one hour, followed by oxygen cutoff conditioning and then nitrogen purging conditioning.

FIGS. 18A and 18B show the conditioning process of the HC membranes from different batches.

### DETAILED DESCRIPTION

The present disclosure relates generally to a cathode starvation method for conditioning a PEMFC comprising a hydrocarbon-based ionomer catalyst layer and a hydrocarbon or PFSA-based proton exchange membrane, and the use of such a conditioned PEMFC. The method and use comprise supplying hydrogen to the anode side of the MEA and oxidant to the cathode side of the MEA to generate an electrical current; adjusting the voltage across the MEA from an open circuit voltage to a first voltage and maintaining the first voltage for a selected first duration; and reducing or stopping the oxygen supply to a cathode side of the membrane electrode assembly while maintaining constant the generated current until either a cutoff time duration or a cutoff voltage is met. The conditioning method is advantageous not only because it provides a conditioning solution for a hydrocarbon based MEA that is difficult to condition using conventional approaches, but also because it can condition a hydrocarbon-based MEA in an exceptionally short time and allows automated operation, both of which can significantly reduce manufacturing costs.

A conditioning process for activating newly manufactured fuel cells is potentially beneficial because it may facilitate the fuel cells in achieving their optimal performance. Fuel cells are electrochemical devices that rely on a complex series of reactions to produce electrical power, and the conditioning process ensures that these reactions take place efficiently. Conditioning may also remove impurities and moisture from the fuel cell, which in turn improves performance and prevents damage. Possible explanations for why conditioning improves the performance of a fuel cell by conditioning are related to increased active catalyst sites as a result of removing contaminants from the catalyst surface and increased proton transfer rate as a result of improved hydration of the MEA.

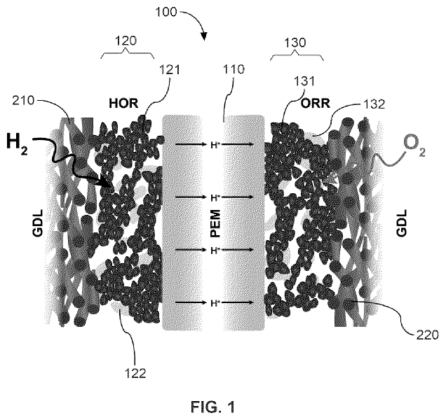

Referring now to FIG. 1, there is shown a schematic of a hydrocarbon-based MEA structure 100 according to embodiments described herein. The MEA structure 100 is formed from a PEM 110 sandwiched between an anode catalyst layer 120 on the anode side of the MEA structure 100 and a cathode catalyst layer 130 on the cathode side of the MEA structure 100. The anode catalyst layer 120 includes anode catalyst particles 121 bonded to the PEM 110 by anode catalyst binders 122. Likewise, the cathode catalyst layer 130 contains cathode catalyst particles 131 bound to the PEM 110 by cathode catalyst binders 132.

The PEM 110 is a thin membrane that allows protons to pass through while blocking the flow of electrons, and may be composed of PFSA ionomers or hydrocarbon-based ionomers. Suitable hydrocarbon-based ionomers include sulfonated polyphenylenes, sulfonated polyarylethers, sulfonated phenylated poly (phenylene) biphenyl (sPPB-H⁺), and sulfonated poly (ether ether ketone) (SPEEK). Alternatively, the PEM may be composed of other materials including inorganic materials, such as sulfonated ceramics and sulfonated polymers, and composites.

The anode and cathode catalyst layers 120 and 130 are responsible for facilitating the electrochemical reactions that take place between the reactants (such as hydrogen and oxygen) and the electrodes (such as platinum particles). Typically, a thin layer of catalyst particles such supported on a carbon-based material forms the anode and cathode catalyst layers 120 and 130. Platinum (Pt) is a commonly used material for the anode and cathode catalyst particles 121 and 131 because it has excellent catalytic activity for the oxygen reduction reaction (ORR) that occurs on the cathode side. Alternative materials that may be suitable for use in the anode and cathode catalyst layers 120 and 130 include palladium (Pd), ruthenium (Ru), and gold (Au), as well as non-platinum group metals such as carbon-based catalysts, collectively known as Metal-Nitrogen-Carbon (M-N—C) catalysts. Various support materials are often used to increase the surface area of the anode and cathode catalyst particles 121 and 131, which may improve the overall efficiency of the fuel cell. These support materials may include carbon black, carbon nanotubes, or other nanostructured materials.

The anode and cathode catalyst binders 122 and 132 are used in the catalyst layers 120 and 130 to hold the anode and cathode catalyst particles 121 and 131, respectively, in place and to provide mechanical stability to the catalyst layers 120 and 130. The binder materials are typically added to a catalyst ink used to prepare the anode or cathode catalyst layer 120 or 130 by coating. The catalyst binder is composed of a hydrocarbon material; examples of suitable hydrocarbon-based catalyst binders include sulfonated polyphenylenes, sulfonated polyarylethers, sulfonated phenylated poly (phenylene) biphenyl (sPPB-H⁺), and sulfonated poly (ether ether ketone) (SPEEK).

As shown in FIG. 1, the anode catalyst layer 120 formed by the anode catalyst particles 121 and the anode catalyst binders 122 is used for the hydrogen-oxidation reaction (HOR). The anode catalyst layer 120 may be coated on one side of the PEM 110 and may be very thin, typically only a few micrometers thick. On the other hand, the cathode catalyst layer 130 formed by the cathode catalyst particles 131 and the cathode catalyst binders 132 is used for the ORR. The cathode catalyst layer 130 may be coated on the other side of the PEM 110 and may be very thin, typically only a few micrometers thick. The MEA structure 100 is an assembly of the PEM 110, the anode catalyst layer 120, and the cathode catalyst layer 130.

Anode and cathode gas diffusion layers (GDLs) 210 and 220 are provided on both sides of the MEA structure 100. The anode and cathode GDLs 210 and 220 are typically made of a porous carbon material that allows gas (such as hydrogen on the anode side and oxygen on the cathode side) to flow through while providing mechanical support for the catalyst layers. The anode and cathode GDLs 210 and 220 also help to distribute the reactant gases over the surface of the catalyst layers, ensuring that the reactants are evenly distributed and react with the catalyst particles.

It will be appreciated that a fuel cell end product may include more components than the MEA and the GDLs. These components may be standardized and commercially available. For example, graphite plates may be provided on either side of the fuel cell to distribute hydrogen or oxygen gas, with a plurality of gaskets between them to seal the gas. For example, current collector plates may be provided to connect the fuel cell to a load. End plates may be provided on either side of the fuel cell to allow hydrogen or oxygen gas to flow in and out. In addition, pairs of nuts and bolts are typically used to secure these components together. Experiments are typically performed on a finished fuel cell with the above components assembled.

### Oxygen Cutoff Conditioning Method

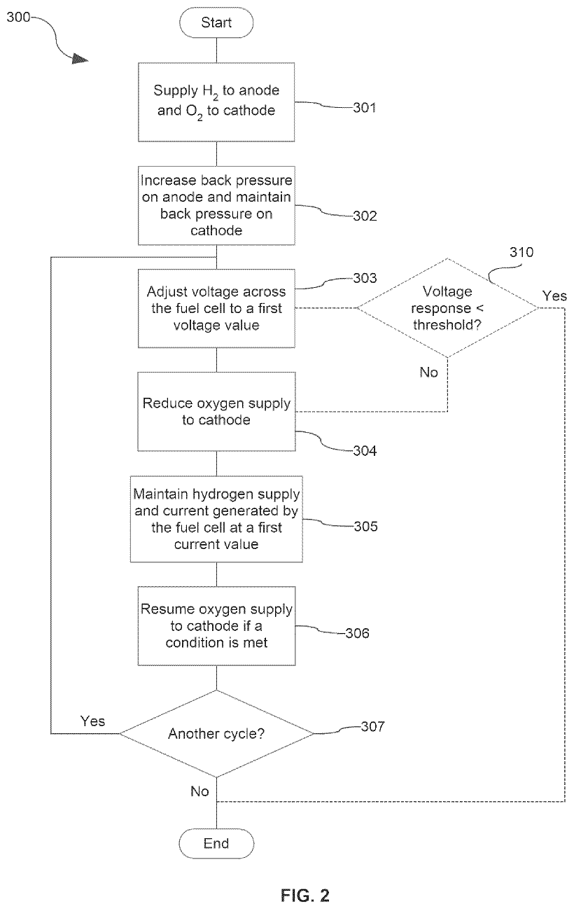

FIG. 2 shows a flow chart for a cathode starvation (through oxygen cutoff) conditioning method 300 for the MEA structure 100 depicted in FIG. 1 according to one embodiment of the present disclosure.

At step 301, hydrogen is supplied to the anode side of the MEA structure 100 through the anode GDL 210 and oxygen is supplied to the cathode side of the MEA structure 100 through the cathode GDL 220. Hydrogen may be supplied to the anode side through an external fuel supply system, such as a pressurized gas cylinder or a reformer system that produces hydrogen from a fuel source such as natural gas or methanol. The hydrogen gas may then be delivered to the anode side of the MEA structure 100 through a flow field, which is a network of channels that distributes the gas uniformly over the surface of the anode catalyst layer 120 through the anode GDL 210. The flow of hydrogen may be controlled by a valve or other flow control device to maintain a constant flow rate and pressure. Similarly, an oxidant such as air may be supplied to the cathode side by an external air supply system, such as a compressor, that delivers ambient air to the cathode side of the fuel cell. The air is then delivered to the cathode side of the MEA structure 100 through a flow field that distributes the air uniformly over the surface of the cathode catalyst layer 130 through the cathode GDL 220. The air flow is typically controlled by a valve or other flow control device to maintain a constant flow rate and pressure.

At step 302, back pressure on the anode side of the MEA structure 100 is increased to a first pressure level, and back pressure on the cathode side of the MEA structure 100 is maintained at an ambient pressure. The first pressure level is greater than the ambient pressure. In a fuel cell, back pressure may be applied to either the anode or cathode side to control the rate of gas flow and maintain a desired operating pressure. On the anode side, for example, back pressure may be applied to help maintain a constant flow rate of hydrogen gas into the fuel cell. This may be accomplished by using a pressure regulating valve or other flow control device that maintains a constant pressure drop across the anode side of the fuel cell. The back pressure created by this valve helps to equalize the pressure of the hydrogen gas on the inlet side of the fuel cell, preventing fluctuations in flow rate due to changes in upstream pressure. Typically, increasing the back pressure may increase the flow rate by increasing the pressure difference across the system, while decreasing the back pressure may decrease the flow rate by decreasing the pressure difference. Although the back pressure on the anode side is set to a first pressure level in this example, it is appreciated that the back pressure on the anode side may be maintained at the ambient pressure as well. Alternatively, the back pressure on the cathode side may be reduced, and for example can be between 3-5 minutes.

At step 303, a voltage across the fuel cell is held at an open circuit voltage (OCV) for a selected open circuit duration, then adjusted from the OCV to a first voltage level, and held at the first voltage level for a first voltage duration. At step 304 and upon completion of the first voltage duration, the oxidant supply is reduced so that little or no air is supplied to the cathode side of the MEA structure 100 (hence “oxygen cutoff”) and the current is held at a selected first current level. This is also referred to as “cathode starvation.” As a result of the oxygen being reduced, the chemical reaction for the fuel cell is stopped, so the voltage across the fuel cell begins to drop. While the voltage across the fuel cell is dropping, the hydrogen supply to the anode side is maintained at step 305. The current generated by the fuel cell is also maintained at the first current level as the voltage drops. The current may be maintained by adjusting the load connected to the fuel cell.

At step 306, the oxygen supply to the cathode side is resumed if one of the following conditions is met: (1) the first current level has been maintained for a predetermined cutoff duration; or (2) the voltage across the fuel cell drops to a cutoff voltage. Then, at step 307, it is to be determined whether to perform another cycle of steps 303 to 306. Although more than one cycle is possible in the conditioning process, it will be appreciated that a single cycle may perform the conditioning with significant improvements in the performance of the fuel cell.

If more than one cycle is to be performed, an optional step 310 may determine a voltage difference between the voltage across the load after the step 303 of the current cycle and the voltage across the load after the step 303 of the previous cycle. If the voltage difference is less than a voltage threshold, the method 300 may end while skipping steps 304 to 307 of the current cycle. Otherwise, the method proceeds to step 304. At step 303, although the voltage across the fuel cell is held at the first voltage level for the first voltage duration, the actual measurement of the voltage across the load (in other words, a voltage response is equal to the current times the resistance of the load) fluctuates. For example, the initial voltage response may be higher than the intended voltage value due to the rapid increase in mass transport of reactant at that point, so holding the voltage for the first voltage duration may allow for a steady flow of reactant, resulting in stabilization of the fuel cell.

The open circuit duration may be set between 0.5 and 15 minutes. The first voltage level may be set at between 0.3 and 0.8 volts, and the first voltage duration may be set at between 3 and 30 minutes. The first current level may be set at between 0.2 and 10.0 A. The cutoff voltage may be set between 0.1 and 0.4 volts and the cutoff duration may be set at 2 to 30 minutes. The voltage threshold may be between 2 and 20 mV. In some embodiments, the open circuit duration is set at 0.5, 1, 5, 10, or 15 minute, the first voltage level is set at 0.3, 0.6, or 0.8 V, the first voltage duration is set at 3, 5, 10, 20, or 30 minutes, the first current level is set at 0.2, 1.0, 5.0, or 10.0 A, the cutoff duration is set at 2, 10, or 30 minutes, and the cutoff voltage is set at 0.1, 0.3, or 0.5 V. The voltage threshold may be 2, 3, 10, 15, or 20 mV. During the conditioning process, the fuel cell may be kept at a temperature of 60 to 90° C. and a relative humidity at 70% to 100% on the anode and cathode sides of the MEA.

In this embodiment, the conditioning method 300 is prepared for MEAs having hydrocarbon-based catalyst binders in the catalyst layers. While the PEM may or may not be hydrocarbon-based, the conditioning method 300 has demonstrated significant advantages over existing conditioning processes for MEAs with hydrocarbon-based catalyst binders.

Experimental setups, measurements, results, and observations are described in detail below to demonstrate various advantages of the conditioning process according to the embodiments of the present disclosure. Certain materials and parameters were selected in the experiments because of their availability, but the present disclosure should not be limited to these materials and parameters, and it should be appreciated that any variations in the selection of materials and parameters that are within reasonable considerations could lead to similar results.

### Experiments (Oxygen Cutoff Conditioning)

Experiments were conducted to test the oxygen cutoff conditioning method on an MEA of a PEMFC and the use of a PEMFC conditioned by the conditioning method.

1. MEA with an HC/HC/HC Configuration

A first batch of MEAs were prepared for conditioning and experimentation. The first MEA has a hydrocarbon-based PEM, hydrocarbon-based anode catalyst binders, and hydrocarbon-based cathode catalyst binders. In short, the first batch of MEAs have an HC/HC/HC configuration (HC/HC/HC MEAs). No PFSA ionomers were used in this configuration.

### 1.1 MEA Preparation

First, the catalyst ink dispersion was prepared. This catalyst ink includes a mixture of 1% solute and 99% solvent. The solute in this ink constitutes Pt/C Ketjen Black catalyst powder (TEC10E50E, lot 109-0111, 46.4% Pt) obtained from Tanaka Kikinzoku Kogyo and sulfonated phenylated poly (phenylene) biphenyl (sPPB-H⁺) ionomer (IEC=3.23±0.04 meq g⁻¹). The Pt/C makes up 85% of the total solute in the catalyst ink, while the sPPB-H⁺ ionomer makes up the remaining 15% of the solute used. The solvent in the catalyst ink was MeOH (ACS reagent ≥99.8%) purchased from Greenfield Global (formerly Commercial Alcohols) and H₂O. The ratio of MeOH to H₂O used was 3:1.

It will be appreciated that, although sPPB-H⁺ was used as an example in the experiments as a hydrocarbon ionomer for catalyst binders and for PEM, other hydrocarbon materials may be used to achieve similar results as well due to similarities in mechanical and chemical properties. Some examples of suitable hydrocarbon-based catalyst binders include sulfonated polyphenylenes, sulfonated polyarylethers, sulfonated phenylated poly (phenylene) biphenyl (sPPB-H⁺), and sulfonated poly (ether ether ketone) (SPEEK). Similarly, other types of catalyst particles may be used to achieve similar results.

The catalyst ink is then sonicated for 2 hours to ensure good homogenization. After homogenization, a spray coater is used to systematically coat both surfaces of a 5 cm² sPPB-H⁺ solid polymer electrolyte membrane with the catalyst ink. Catalyst ink was deposited on sPPB-H⁺ membranes using a spray coater (Sono-tak ExactaCoat) equipped with an ultrasonic accumulation nozzle with an outlet diameter of 3 mm and operated at 120 kHz, with a hot plate set at 80° C. The same path was configured with a velocity of 75 mm/s on a 2D path, including a horizontal spray followed by a vertical spray for each sample. The ink flow rate of the spray coater was set to 0.3 ml/min, the shaping air was set to 0.8, and the idle and running generator power was set to 0.5 W and 2 W, respectively. Each side of the membrane is coated to have 0.4 mg of Pt per cm² (0.4 mgₚₜ/cm²), and the presence of the sPPB-H⁺ ionomer in the catalyst ink helps to bind the catalyst ink to the surface of the membrane during and after spray coating.

To complete the PEMFC assembly, the catalyst coated membrane was sandwiched between two 6.5 cm² Sigracet 22BB PTFE treated gas diffusion layers (GDL) purchased from FuelCellStore and pressed into fuel cell hardware (AHNS Co.) to form the membrane electrode assembly (MEA). The MEA was sandwiched between two 130 μm glass fiber reinforced PTFE gaskets (Hightechflon GbR) and a 50 μm silicone sub-gasket to ensure a perfect seal. The sealed MEA was sandwiched between 2 serpentine graphite flow fields and attached to 2 gold-plated current collectors on 2 end plates. The fuel cell was then tightened using nuts and bolts and a torque wrench. To obtain uniform pressure distribution, tests were performed on our hardware with eight bolts at different applied torques, from 0.5 to 6.0 Nm with 0.5 Nm increments. Optimum compression was achieved at 5.7 Nm.

The fuel cell was then connected to a Scribner Teledyne Medusa 890CL fuel cell test station. The fuel cell was first conditioned, and then the performance of the fuel cell was determined using electrochemical characterization tools such as polarization and power curve, cyclic voltammetry, linear sweep voltammetry, and electrochemical impedance spectroscopy. An accelerated degradation process was then used to determine the durability of the fuel cell.

### 1.2 Conditioning

Conditioning was performed at a high back pressure only on the anode side, while the back pressure on the cathode side was maintained at ambient pressure. For example, the back pressure used on the anode side was approximately 30 psi (or approximately 2 bar). The higher back pressure on the anode side was used to compensate for the lower gas-over rate observed with hydrocarbon-based catalyst binders, whose flow rate is typically less than 50% of the flow rate of a PFSA-based MEA. Thus, increasing the back pressure on the anode side helps to increase the potential for fuel transport from the anode side to the cathode side.

The conditioning cycles were the same as those described from step 303 to step 307 with respect to FIG. 2, and were automated. The automation assists with gas switching and ensures that each cycle is precisely timed, thereby mitigating against human error that is likely to occur when the gas is manually turned on and off.

In addition to the cathode starvation conditioning process described herein, three conditioning processes were performed as a control. The three additional conditioning processes are the amperometric conditioning process (amperometric), the harmonized conditioning process proposed by the European Union Joint Research Center (EU), and the standard conditioning process proposed by the United States Department of Energy (DOE). A total of 12 MEAs were fabricated and 3 independent MEAs were activated per amperometric, EU, DOE, and cathode starvation conditioning processes.

The amperometric conditioning process is a galvanostatic activation process. The current was increased linearly from 2 A (400 mA/cm²) to 15 A (3,000 mA/cm²). Five cycles were repeated over an 18 hour period.

The EU conditioning process is a galvanostatic activation process with the following steps: (i) the power density response was monitored as the current density was ramped from 0.5 A (100 mA/cm²) to 4 A (800 mA/cm²) and allowed to stabilize for 6 hours; (ii) the voltage response was monitored at a constant current of 5 A (1,000 mA/cm²) for 2 hours at 50% relative humidity (RH); and (iii) the voltage was then cycled between 0.75 V and 0.45 V. Three cycles were repeated.

The DOE conditioning process is a potentiostatic activation process. The voltage was cycled between OCV (held for 1 second) and 0.55 V (held for 1 hour). Nine cycles were repeated.

The cathode starvation conditioning was substantially the same as the conditioning method 300 described above. The conditioning configurations and parameters actually used were added, with the conditioning process described below as a series of steps:
a) During the test, the inlet gas flows were set at 0.5 standard liter per minute (slpm) hydrogen at the anode side and 1.0 slpm oxygen at the cathode side, and the fuel cell temperature was set at 80° C., 100% RH at both electrodes, 30 psi anode backpressure, and ambient cathode pressure.

b) The fuel cell was first held at open circuit voltage (OCV) for 1 minute at a scan interval of 1 second per point.

c) The fuel cell voltage was then ramped from OCV to 0.5 V at a scan interval of 0.2 second per point and 2 mV per point. The fuel cell voltage may be adjusted by connecting a load to the fuel cell.
d) After reaching 0.5 V, the fuel cell was held at this constant voltage for 5 minutes.
e) After stabilizing at 0.5 V, the cathode gas flow rate was reduced to zero, shutting off the oxygen gas supply and “starving” the cathode.
f) The fuel cell was then held at a constant current of 0.5 A by adjusting the load, with H₂ flowing through the anode and the cathode starved of oxygen. The fuel cell voltage began to drop rapidly due to the lack of oxygen at the cathode, and this process was allowed to continue for 5 minutes or until the fuel cell voltage reached a cutoff voltage of 0.3 V, whichever came first.
g) When 0.3V was reached, or after 5 minutes of cathode starvation, the oxygen gas was resupplied to the cathode. The reason why the voltage was replenished at 0.3V was to ensure that cell reversal losses do not occur, as this would cause permanent damage to the fuel cell.
h) This conditioning process was then repeated until the difference in the voltage response measured after the above step d) between two successive conditioning cycles was less than 5 mV, which typically occurred after 5 cycles during the experiments.

The hydrocarbon-based (such as sPPB-H⁺) catalyst binders and hydrocarbon-based (such as sPPB-H⁺) PEM exhibit high proton conductivity compared to the PFSA binders and PEM. This high conductivity results in a steep drop in potential between 0.4 and 0.2 V. Surprisingly, it was found that when the cell potential drops below 0.2 V, there is a high risk of irreversible damage to the fuel cell due to cell reversal. To mitigate against human error, the experimental cathode starvation conditioning process was automated and the cut-off voltage potential was set at 0.3 V, after which cathode gas was replenished.

Because of the low gas crossover, the back pressure is set at a relatively high value, such as 30 psi or 2 bar, to increase the rate of gas transport from the anode side to the cathode side, which is expected to be material to the conditioning process. Also, it was observed that because the fuel cell retains oxygen even when the cathode is starved, the low gas crossover rate significantly increases the time it takes for the cell voltage to drop to 0.3 V. To overcome this, an additional condition was introduced to trigger the resupply of oxygen—the starvation cut off time was set to 5 minutes regardless of the voltage across the fuel cell unless the voltage drops to 0.3 V first. This additional condition did not adversely affect the rate of cell conditioning.

It will be appreciated that although some of the above parameters have been run at a particular value, variations are possible. For example, the back pressure on the anode side for increasing the gas crossover rate may be set to a higher value, such as 36 to 44 psi, or to a slightly lower value, such as 22 psi; the cell temperature may be set to a higher or lower value, such as 75° C. or 90° C.; the OCV may be maintained for longer (such as 3 minutes), shorter (such as 30 seconds), or even none; the voltage may be ramped to a higher or lower value, such as 0.6 or 0.4 V; the voltage may be maintained for longer (such as 10 minutes), shorter (such as 1 minutes); the constant current may be maintained at a higher or lower value, such as 1 or 0.4 A; the cathode starvation may be maintained for longer or shorter, such as 10 minutes or 4 minutes; the cutoff voltage may be set at a higher or lower value, such as 0.35 V or 0.2 V; and the voltage difference threshold may be set at a higher or lower value, such as 7 mV or 4 mV.

### 1.3 Measurements and Performance

Prior to measurement, the cell was equilibrated at OCV. Polarization and power curve analyses were performed to determine the current-voltage relationship as a measure of the performance of the MEA. Additional electrochemical analyses, including electrochemical impedance spectroscopy (EIS), cyclic voltammetry (CV), and linear sweep voltammetry (LSV), were performed to examine various aspects of performance. For each figure and curve, the best-in-class data from the 3 samples tested were reported. Where appropriate, error bars have been inserted to indicate the associated standard deviation.

For the polarization and power curve analyses, the fuel cell was operated at 80° C., ambient pressure, and 100% RH with inlet gas flows of 0.5 slpm hydrogen on the anode side and 1.0 slpm oxygen on the cathode side. After conditioning and equilibration, polarization curves were recorded from OCV to a cutoff potential of 0.3 V over 200 mA steps, measured at a scan interval of 5 minutes per point. The resolution of the kinetic region was determined by current scanning from 0.00 to 0.20 A over 0.01 A steps at a scan interval of 1 minute per point. Similarly, the ohmic region was scanned from 0.50 A to 1.50 A with 0.50 A steps at a scan interval of 5 minutes per point. Finally, the mass transfer region of the polarization curve was obtained by scanning from 2 A to 15 A using 1 A steps at a scan interval of 5 minutes per point.

The EIS analysis was performed on fuel cells equilibrated under 0.5 slpm H₂ on the anode side and 1 slpm O₂ (or 0.5 slpm N₂ for determining the ionic resistance in the catalyst layer) on the cathode side once stable potentials of less than 0.15 V were reached. To determine the ionic resistance in the catalyst layer, an AC voltage amplitude of 10 mV was applied and frequency scans were performed from 100 KHz to 100 mHz. EIS characterization was then performed potentiostatically at 0.8 V. A Randle's equivalent circuit model was used to extract meaningful information from the obtained EIS data by modeling the different regions of the fuel cell as an electrical circuit. The corresponding impedance data were then plotted in a Nyquist plot and fitted in Zview™ software using a simple Randles circuit.

The CV analysis was performed at a temperature of 80° C., 100% RH, and 1 atmosphere (atm) back pressure. The inlet gas flows were 0.5 slpm hydrogen at the anode and 0 slpm oxygen at the cathode. The initial potential (V) was set at 0.4 V with a low and high peak potential of 0.04 V and 0.80 V vs. RHE, respectively. The scan rate used for each CV scan was set to 0.05 V/s after an initial potential hold at 0.4 V vs. RHE for 45 s, and the current range was set to 2 A.

The LSV analysis was performed on the cell to determine the H₂ crossover rate. The LSV measurement was performed under 0.5 slpm H₂/N₂ measurement at the anode/cathode electrodes. A VersaSTAT3 potentiostat was used with a scan rate of 2 mV/s with the potential swept between 0 and 0.6 V at a current range of 2 A for 5 minutes.

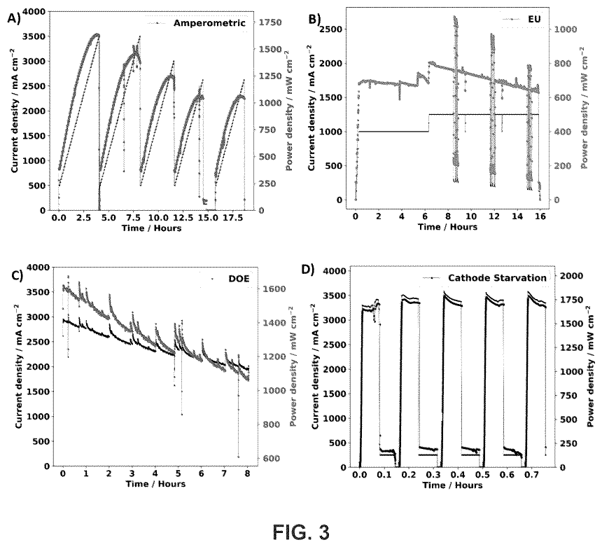

FIG. 3 shows a plot of the conditioning profiles of the four conditioning processes discussed above for an HC/HC/HC MEA. In this experiment, sPPB-H⁺ ionomers were used for both the PEM and the catalyst binders.

In the amperometric process shown in FIG. 3 (A), five amperometric conditioning cycles were performed on the HC/HC/HC MEAs. A trend of decreasing peak power density with increasing conditioning cycles was observed, with the first cycle providing a peak power of 1,580 mW/cm² and the second cycle providing 1,390 mW/cm². The peak power density stabilized between the fourth and fifth cycles, but at the expense of a reduced peak power density of 1,250 mW/cm², namely, a 21% reduction in peak power density between the first and fifth cycles. This observation indicates that the amperometric conditioning process is not suitable for activating HC/HC/HC MEAs, as conditioning results in decreased rather than improved performance.

In performing the EU process shown in FIG. 3 (B), three conditioning cycles were performed on the HC/HC/HC MEAs. A similar performance drop was reported after each cycle as noticed for the amperometric-conditioned MEAs. A peak power density of 1,140 mW/cm² was observed after the first cycle, but after the third cycle, the peak power density decreased to 30% of its original value, to 795 mW/cm², indicating that the standardized EU conditioning process is not suitable for activating this class of MEAs.

In the DOE process shown in FIG. 3 (C), nine conditioning cycles were repeated on the HC/HC/HC MEAs. As the number of conditioning cycles increased, a significant decrease in performance was observed. The peak power density was reduced by more than 31%, from 1,570 mW/cm² for the first cycle to 1,090 mW/cm² after the ninth cycle, indicating that this process (DOE) is also not optimal for conditioning the HC/HC/HC MEAs, although it is a standard conditioning method for PFSA-based MEAs.

In the cathode starvation process shown in FIG. 3 (D), the HC/HC/HC MEAs were subjected to five conditioning cycles, and unlike the other three conditioning processes, the peak power density surprisingly increased with the number of conditioning cycles. A 15% increase in peak power density was observed from the first (1,560 mW/cm²) to the fifth (1,790 mW/cm²) cycle, with performance stabilizing between the fourth and fifth cycles, indicating a relatively short conditioning time.

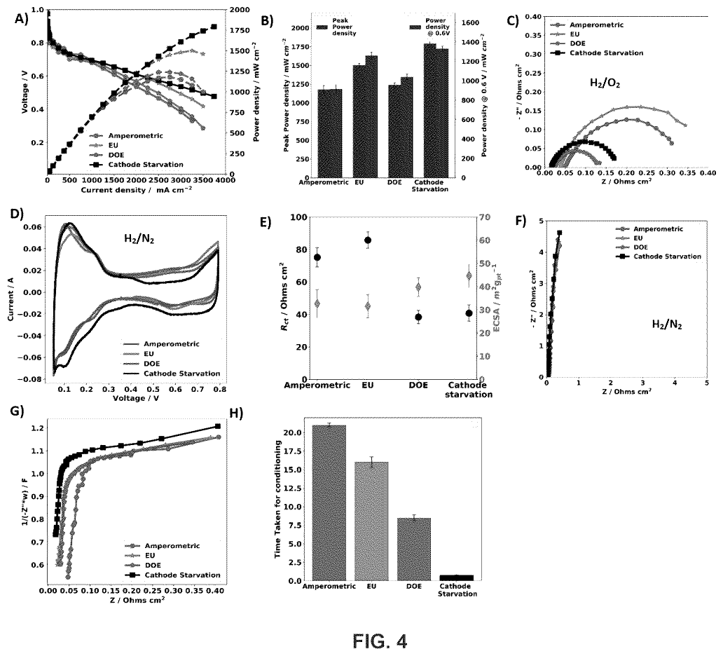

FIG. 4 shows performance plots of HC/HC/HC MEAs subjected to the four aforementioned conditioning processes under the condition of 80° C., 100% RH and 1 atm pressure: (A) polarization and power curves immediately after conditioning; (B) peak power density at 0.6 V; (C) Nyquist plots obtained from EIS spectra recorded at 0.8 V under the H₂/O₂ configuration; (D) ECSA Pt loadings of 0.4 mg_{Pt}/cm² for cathode and anode under the H₂/N₂ configuration; (E) relationship between ECSA (m²·gₚₜ⁻¹) and charge transfer resistance (mΩ·cm²); (F) EIS plot illustrating the high-frequency intercept and low-frequency intercept by a linear fit of the low-frequency data to determine the ionic resistance of the catalyst layer of the MEAs under the H₂/N₂ configuration; (G) capacitance plots obtained from the EIS measurements of the catalyst ionic resistance; (H) time taken to condition each of the MEAs.

First, as shown in FIG. 4 (H), the total activation time for the amperometric, EU, DOE, and cathode starvation conditioning processes were 21 hours, 16 hours, 8 hours, and 40 minutes, respectively. This shows the extent to which the cathode starvation process could reduce the conditioning time required for HC/HC/HC MEAs.

To further characterize the HC/HC/HC MEAs, the membrane resistance (Rₘₑₐ) was examined. From the high frequency intercept of the Nyquist plots shown in FIG. 4 (C), Rₘₑₐ values ranged from 6-10 mΩ·cm²—this is not unexpected as the same MEA compositions were used throughout. It is noted that HC/HC/HC MEAs conditioned by the amperometric process yielded the highest Rₘₑₐ, while the cathode starvation conditioning process yielded the lowest Rₘₑₐ, from which it is inferred that the accelerated cathode starvation conditioning method results in HC/HC/HC MEAs that are well hydrated and possess the highest proton conductivity after conditioning. As shown in Table 1 below, both cathode starvation and DOE-conditioned HC/HC/HC MEAs have a similar membrane resistance, despite the significantly different conditioning times. Similarly, EU and amperometric process conditioning yielded HC/HC/HC MEAs with equal Rₘₑₐ values.

Charge transfer resistance (R_{ct}) was also estimated from the Nyquist plots shown in FIG. 4 (C), and it was found that HC/HC/HC MEAs conditioned by cathode starvation and DOE process yielded similar R_{ct} values of 40 mΩ·cm², which are 47% and 53% higher than the R_{ct} values obtained for the amperometric (75 mΩ·cm²) and EU (85 mΩ·cm²) conditioned HC/HC/HC MEAs, respectively. This is an indication that the cathode starvation process results in HC/HC/HC MEAs that have a higher rate of ORR activity, which is often characterized by lower R_{ct} values and is synonymous with reduced activation polarization.

The electrochemical surface areas (ECSA) were extracted from the CVs shown in FIG. 4 (D) and extracted data are listed in Table 1 below. The cathode starvation conditioned HC MEAs showed the highest ECSA among the four conditioning methods studied. A trend between ECSA and R_{ct} is shown in FIG. 4 (E), where an inverse relationship between R_{ct} and ECSA is observed. The EIS impedance plots showing the ionic resistance of the catalyst layer (R_{ionic}) are shown in FIG. 4 (F). As observed, the cathode starvation conditioned MEA had the steepest slope, indicating a lower resistivity, while the amperometric conditioned MEA had the lowest slope and the highest resistivity of the four MEAs considered. Thus, the cathode starvation process resulted in HC/HC/HC MEAs with the lowest R_{ionic}. Conversely, the amperometrically conditioned MEA showed significantly higher R_{ionic} values, 2 times greater, indicating that the cathode starvation process increases the proton conduction of the catalyst layers of HC/HC/HC MEAs.

From the I-V performance analyses as shown in FIG. 4, it was determined that the cathode starvation conditioning processes results in HC/HC/HC MEAs with higher peak power density. The catalyst layers of MEAs conditioned by the cathode starvation process also show higher ORR activity with higher activated catalyst sites. This process results in low ionic resistivity, indicating that the MEAs were well humidified. The standardized amperometric, DOE, and EU processes provide varying lower activity and higher resistivity compared to the cathode starvation process according to the embodiments of the present disclosure.

### 1.4 Durability Tests

Since one of the objectives of the present disclosure is to improve the longevity of a fuel cell after conditioning, the performance of the fuel cell after aging was tested. The aging process was performed using an accelerated degradation process. The fuel cell was tested at 80° C., 100% RH, and 30% RH at both the anode and cathode. The aging process was accelerated through the following steps: the fuel cell was held at OCV for 8 seconds; a voltage scan was performed in the order of OCV to 0.6V to OCV, at a scan rate of 50 mV/s; then the two steps were repeated for up to 9,000 cycles, with the performance of the fuel cell being characterized after every 3,000 cycles.

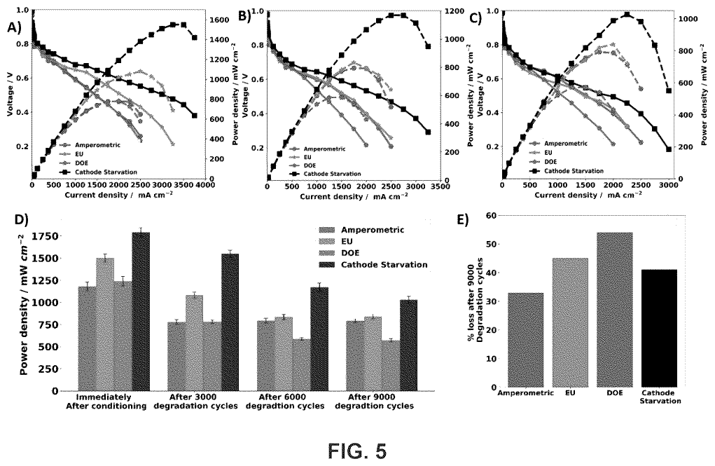

FIG. 5 shows I-V polarization and power density plots of HC/HC/HC MEAs subjected to the four conditioning processes under the conditions of 80° C., H₂ anode and O₂ cathode, 100% RH, and 1 atm pressure: (A) after 3000 degradation cycles; (B) after 6000 degradation cycles; (C) after 9000 degradation cycles; (D) graph showing the corresponding peak power density plots of MEAs before and after each degradation cycle; and (E) percent power loss comparing the peak power density immediately after conditioning and after 9000 degradation cycles.

The durability of the HC/HC/HC MEAs conditioned by the four processes was investigated by analyzing polarization and power density plots after 3000, 6000 and 9000 degradation cycles. As judged from the plots from FIG. 5 (A) to (D), the cathode starvation conditioned HC/HC/HC MEA exhibited the highest peak power after each accelerated degradation cycle. Comparing the peak power density immediately after conditioning to the peak power density after 9,000 degradation cycles, as shown in FIG. 5 (E), the DOE-conditioned HC/HC/HC MEA experienced the largest decrease in peak power density, with ~55% power loss from 1,240 mW/cm² (0 degradation cycles) to 787 mW/cm² after 9,000 degradation cycles. The EU process-conditioned MEA showed a 45% power loss, with peak power densities dropping from 1,500 mW/cm² to 840 mW/cm² after 9,000 degradation cycles. The cathode starvation conditioning process showed a 41% decrease in peak power density, dropping from 1,790 mW/cm² to 1,030 mW/cm² after 9,000 degradation cycles. The amperometric conditioning process exhibited the lowest peak power density after conditioning and gave the least power loss of 32%, dropping from 1,180 mW/cm² to 787 mW/cm² after 9,000 degradation cycles. However, its peak power density after 9,000 degradation cycles is 31% lower than the peak power density of the cathode starvation conditioned HC/HC/HC MEA. In addition, from FIG. 5 (A), before degradation, the amperometric conditioned MEA reaches its cutoff voltage limit (0.3 V) at a lower current density of 2500 mW/cm² compared to other processes. This poor initial performance is believed to be the reason for the erratic I-V response of the amperometric conditioned HC/HC/HC MEA.

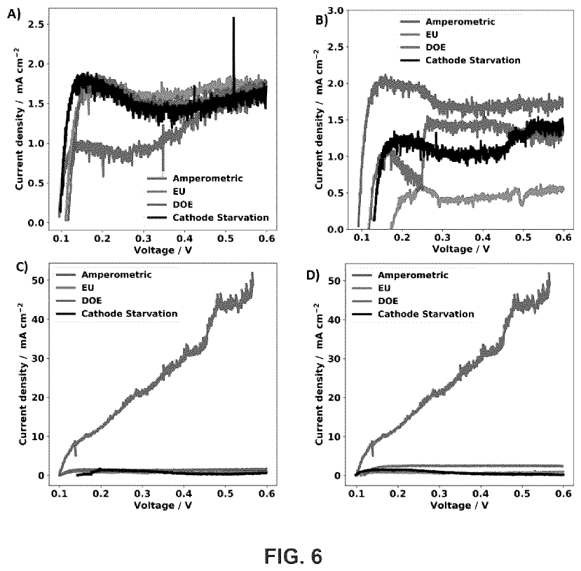

FIG. 6 shows a linear sweep voltammetric analysis of HC/HC/HC MEAs: (A) immediately after conditioning; (B) after 3,000 degradation cycles; (C) after 6,000 degradation cycles; (D) after 9,000 degradation cycles. LSV measurements were data obtained under the conditions of 80° C., H₂ anode and N₂ cathode, 100% RH, and 1 atm pressure.

The rate of hydrogen crossover through HC/HC/HC MEAs conditioned by the four conditioning cycles was determined using LSV measurements under H₂/N₂ operation, as shown in FIG. 6 (A). The MEAs exhibited similar gas crossover values after conditioning, with the current density at 0.5 V well below 2.5 mA/cm² (1.46, 1.54, 1.49, and 1.47 mA/cm² for amperometric, DOE, EU, and cathode starvation conditioned MEAs, respectively), indicating low gas crossover and the absence of pinholes in the MEA. After 3,000 degradation cycles (FIG. 6 (B)), the EU, DOE, and cathode starvation conditioned MEAs showed a decrease in current response, while the amperometric activated MEA showed almost the same value as its freshly conditioned state. After 6,000 cycles and 9,000 cycles, as shown in FIG. 6 (C) and (D), respectively, it is observed that there is a significantly high current response reported for the amperometric-based MEA, indicating a high gas crossover rate and consequently a breach in the mechanical integrity of the MEA and the formation of electrical shorts. However, the DOE, EU, and cathode starvation conditioned HC/HC/HC MEAs were able to maintain their mechanical integrity after degradation (FIG. 6 (D)). The current density responses of the DOE, EU, and cathode starvation conditioned MEAs at 0.5 V were reported to be 2.48, 0.76, and 0.44 mA/cm², respectively, and are all within acceptable crossover limits, namely, <2.5 mA/cm² for PEMFC operation.

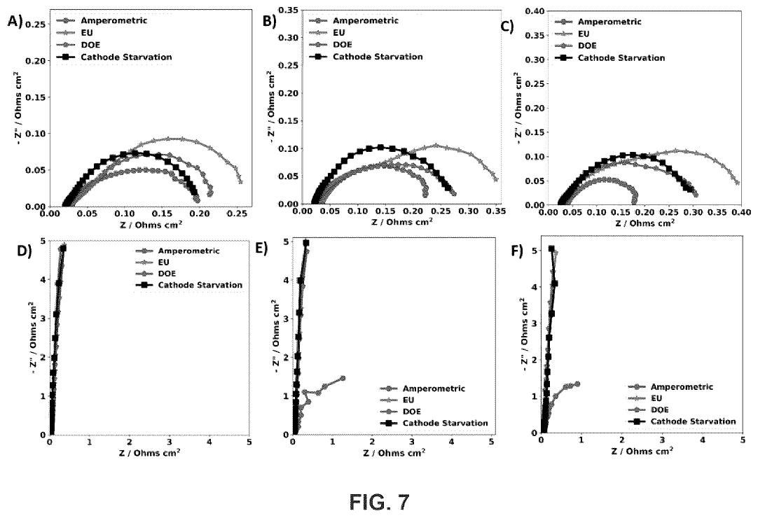

FIG. 7 shows the comparison of Nyquist plots with EIS spectra recorded under the conditions of 0.8 V, 80° C., H₂ anode and O₂ cathode: (A) after 3,000 degradation cycles; (B) after 6,000 degradation cycles; (C) after 9,000 degradation cycles; as well as the comparison of Nyquist plots, illustrating the high-frequency intercept and low-frequency intercept by linearly fitting low-frequency data to determine the ionic resistance of the catalyst layer, under the conditions of 100% RH, 1 atm pressure, H₂ anode and N₂ cathode: (D) after 3,000 degradation cycles; (E) after 6,000 degradation cycles; (F) after 9,000 degradation cycles.

The EIS spectra of the HC/HC/HC MEAs were also acquired after each accelerated degradation and are shown in FIG. 7. As can be seen from Table 1 below, there were no significant changes in the membrane resistances before and after degradation for each of the conditioning processes studied. The charge transfer resistance (R_{ct}) recorded for each MEA was observed to increase as the number of accelerated degradation cycles increased, regardless of the conditioning process used.

The only anomaly was the MEA conditioned using the amperometric process, which showed an initial decrease with the number of degradation cycles before increasing with prolonged cycling. Based on the data shown from the LSV data in FIG. 6, it was observed that after the 6,000 degradation cycle, the MEAs conditioned by the amperometric process experienced significant gas crossover, thus reducing the integrity of the data obtained after the 6,000 degradation cycles. After 9,000 degradation cycles, the cathode starvation process was found to have the lowest R_{ct}.

Comparing the different conditioning processes, as shown in Table 1 and FIG. 7 (D), (E), and (F), it was observed that the ionic resistance (R_{ionic}) of the catalyst layer is lowest for the cathode starvation process after 9,000 degradation cycles (cathode starvation, 1.48 mΩ·cm²; DOE: 2.11 mΩ·cm²; EU: 2.27 mΩ·cm²). Thus, it can be concluded that the cathode starvation conditioning process yields HC/HC/HC MEAs that are well hydrated and maintain their performance for a longer period of time compared to the other processes. The R_{ionic} values of the amperometrically conditioned MEAs are not included due to the high gas crossover observed in the MEAs after 6,000 degradation cycles as shown in the LSV measurements.

TABLE 1
HC/HC/HC MEA resistance data immediately after conditioning and after accelerated
degradation cycles for MEAs conditioned by different processes.

| Conditioning process | | Amperometric | EU | DOE | Cathode Starvation |
|---|---|---|---|---|---|
| After conditioning | Rₘₑₐ (mΩ cm²) | 10.1 ± 2.4 | 9.8 ± 1.8 | 6.2 ± 2.7 | 6.0 ± 2.6 |
| (0 cycles) | R_{ct} (mΩ cm²) | 75.1 ± 8.3 | 85.7 ± 7.9 | 38.3 ± 5.2 | 40.7 ± 4.1 |
| After 3,000 cycles | Rₘₑₐ (mΩ cm²) | 6.4 ± 1.8 | 6.9 ± 1.4 | 7.5 ± 2.1 | 5.3 ± 2.2 |
| | R_{ct} (mΩ cm²) | 46.2 ± 8.8 | 95.4 ± 7.7 | 50.3 ± 9.4 | 45.0 ± 5.4 |
| After 6,000 cycles | Rₘₑₐ (mΩ cm²) | 8.8 ± 1.9 | 6.1 ± 2.3 | 6.4 ± 1.6 | 5.5 ± 1.8 |
| | R_{ct} (mΩ cm²) | — | 103.4 ± 18.3 | 67.8 ± 8.4 | 62.2 ± 9.5 |
| After 9,000 cycles | Rₘₑₐ (mΩ cm²) | 9.7 ± 3.1 | 6.01 ± 2.8 | 6.8 ± 2.4 | 5.5 ± 2.9 |
| | R_{ct} (mΩ cm²) | — | 111.7 ± 22.7 | 73.1 ± 11.8 | 69.7 ± 12.1 |

Catalyst Layer Ionic Resistance

| | | | | | |
|---|---|---|---|---|---|
| After conditioning | R_{ionic} (mΩ cm²) | 3.8 ± 1.8 | 1.6 ± 0.9 | 1.9 ± 0.9 | 1.0 ± 0.7 |
| After 3,000 cycles | R_{ionic} (mΩ cm²) | 1.6 ± 2.4 | 1.5 ± 0.2 | 1.6 ± 0.8 | 1.1 ± 0.7 |
| After 6,000 cycles | R_{ionic} (mΩ cm²) | — | 2.7 ± 1.1 | 2.6 ± 0.9 | 1.1 ± 0.6 |
| After 9,000 cycles | R_{ionic} (mΩ cm²) | — | 2.3 ± 1.2 | 2.1 ± 0.4 | 1.6 ± 0.93 |

ECSA

| | | | | | |
|---|---|---|---|---|---|
| After conditioning | m²/gₚₜ | 32.6 ± 4.4 | 31.5 ± 3.6 | 39.7 ± 2.3 | 44.6 ± 3.6 |
| After 3,000 cycles | m²/gₚₜ | 27.6 ± 3.9 | 27.6 ± 3.8 | 35.1 ± 3.1 | 39.6 ± 2.9 |
| After 6,000 cycles | m²/gₚₜ | — | 22.6 ± 1.9 | 28.1 ± 2.9 | 31.9 ± 4.4 |
| After 9,000 cycles | m²/gₚₜ | — | 20.5 ± 4.5 | 26.7 ± 1.9 | 29.7 ± 2.6 |

### 1.5 Conclusion

The effect of standardized conditioning processes on HC/HC/HC MEAs containing sPPB-H⁺ was investigated. The standardized conditioning processes studied included the DOE and EU harmonized processes, an amperometric conditioning process, and an accelerated conditioning process based on cathode starvation. Using the same parameters and characterization techniques for these processes, it was found that the DOE, EU, and amperometric conditioning processes were ineffective for conditioning the HC/HC/HC MEAs, as the peak power density of the HC/HC/HC MEAs decreased with increasing conditioning cycles. Only the cathode starvation conditioning showed increasing MEA peak power density with increasing conditioning cycle. When comparing performance after conditioning, the cathode starvation process showed the highest peak power density of 1,790 mW/cm², which was 20%, 45%, and 52% greater than the EU (1,500 mW/cm²), DOE (1,240 mW/cm²), and amperometric (1,180 mW/cm²) conditioned MEAs, respectively. The cathode starvation process also resulted in MEAs with the highest double layer capacitance (indicating lower catalyst layer resistivity), ECSA, and the highest proton conduction within the catalyst layer. After 9,000 accelerated degradation cycles, the cathode starvation conditioned HC/HC/HC MEAs exhibited the highest peak power density. The DOE and EU conditioning processes resulted in the highest power loss, with more than 55% and 45% of their initial power lost after degradation, respectively. After 6,000 degradation cycles, the amperometric conditioned MEAs lost their mechanical integrity. EIS analysis showed that after 9,000 degradation cycles, the cathode starvation conditioned MEA had the lowest charge transfer resistance and the lowest ionic resistance of the catalyst layer, in addition to the highest ECSA of the processes considered.

It is noted that standard conditioning processes used to effectively activate conventional type of MEAs (such as PFSA-based MEAs) was not as effective in conditioning HC/HC/HC MEAs. However, it is surprising that the cathode starvation process according to the embodiments of the present disclosure was unexpectedly effective and advantageous in conditioning this type of MEA in terms of initial performance and durability. In addition, it was found that the activation time can be significantly reduced compared to existing conditioning processes, which is particularly advantageous in terms of cost savings.

2. MEA with a PFSA/HC/PFSA Configuration

A second batch of MEAs were prepared for conditioning and experimentation. The second MEA had a hydrocarbon-based PEM, PFSA-based anode catalyst binders, and PFSA-based cathode catalyst binders. In short, the second batch of MEAs had a PFSA/HC/PFSA configuration (PFSA/HC/PFSA MEAs).

PFSA Nafion® D520 ionomers were used to replace the sPPB-H⁺ used for the catalyst binders on both the anode and cathode sides of the HC/HC/HC MEAs. Other setups and conditions were identical to those described in Section 1.1. Conditioning was performed in an identical manner to that described in Section 1.2. Configurations and methodologies for measuring data and testing the performance and durability were identical to those described in Sections 1.3 and 1.4.

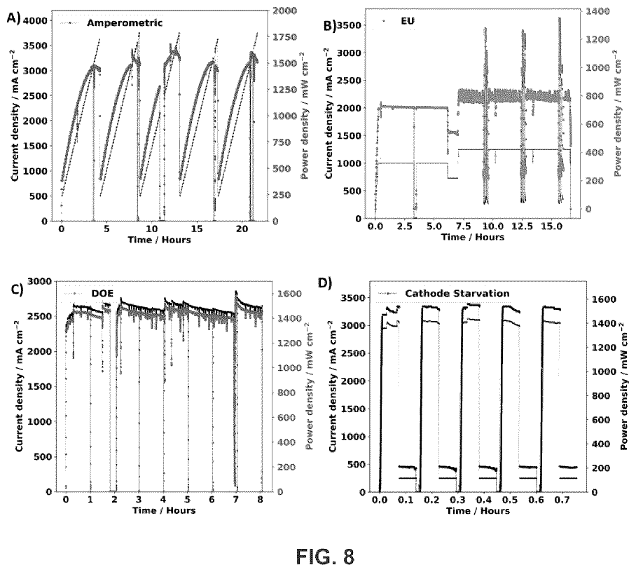

FIG. 8 shows a plot of the conditioning profiles of the four conditioning processes discussed above for a PFSA/HC/PFSA MEA. In this experiment, sPPB-H⁺ ionomers were used only for the PEM and PFSA ionomers were used for the catalyst binders.

First, it was evident that each of the conditioning processes effectively conditioned the MEAs, and the results were similar to those for MEAs with PFSA for both the PEM and the catalyst binders. This indicates that the type of ionomer in the catalyst layer has a greater influence on the choice of conditioning process than the type of PEM used. Despite the use of an sPPB-H⁺ membrane, a good activation profile was achieved for all of the amperometric, EU, and DOE conditioning protocols, which was not the case for an HC/HC/HC MEA configuration.

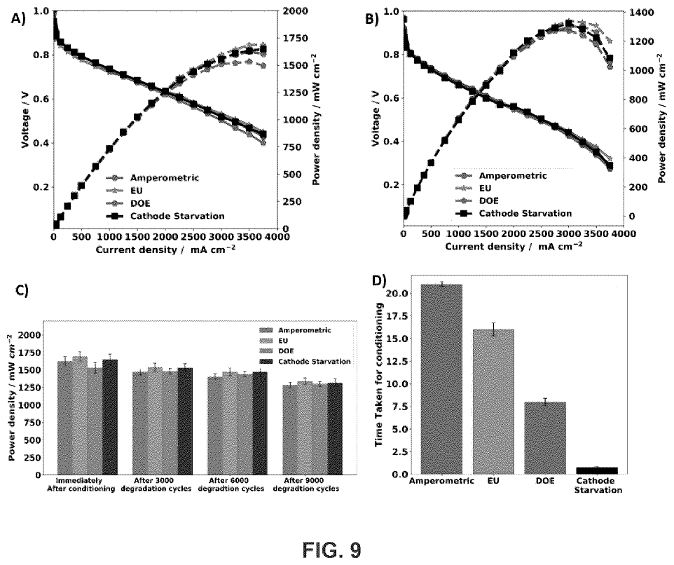

FIG. 9 shows performance plots of PFSA/HC/PFSA MEAs subjected to four conditioning processes: (A) polarization and power curves immediately after conditioning; (B) polarization and power curves after 9,000 degradation cycles; (C) performance data with error bars showing the maximum power density of the MEAs conditioned by the four conditioning protocols after conditioning and after 3,000, 6,000, and 9,000 degradation cycles; (D) time taken to condition each of the PFSA/HC/PFSA MEAs.

It is noted that both the performance profile and the durability profile of all the conditioning processes were within the range of each other, indicating that for the PFSA/HC/PFSA MEA configuration, any of the conditioning processes may be used to achieve good performance and sustained durability. It also shows that the effectiveness of the cathode starvation process not only indicates good performance but also sustained durability regardless of the type of catalyst binder. In addition, this is achieved in less than 45 minutes, which is more than 90% less time than the standard DOE, EU, or amperometric conditioning process.

3. MEA with a HC/PFSA/HC Configuration

A third batch of MEAs were prepared for conditioning and experimentation. The third MEA had a PFSA-based PEM, hydrocarbon-based anode catalyst binders, and hydrocarbon-based cathode catalyst binders. In short, the second batch of MEAs had a HC/PFSA/HC configuration (HC/PFSA/HC MEAs).

PFSA Nafion® D520 ionomers were used to replace the sPPB-H⁺ used for the PEM of the HC/HC/HC MEAs. Other setups and conditions were identical to those described in Section 1.1. Conditioning was performed in an identical manner to that described in Section 1.2. Configurations and methodologies for measuring data and testing the performance and durability were identical to those described in Sections 1.3 and 1.4.

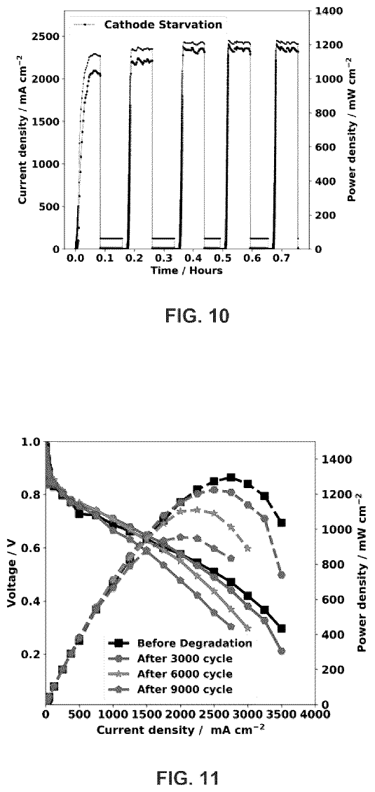

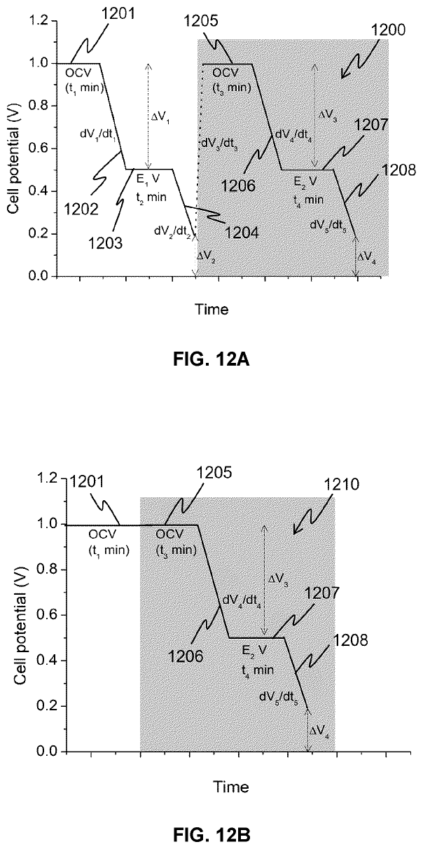

FIG. 10 shows power density and current density as a function of conditioning time for cathode starvation conditioned for HC/PFSA/HC MEAs. FIG. 11 shows the polarization and power curve profile of HC/PFSA/HC MEAs under the conditions of 80° C., 100% RH, 1 atm pressure, H₂ anode and O₂ cathode. Only the cathode starvation according to the embodiments of the present disclosure was carried out because the influence of the type of PEM was to be found out for the cathode starvation process.

It is noted that the initial performance of the HC/PFSA/HC MEA peaked between the fourth and fifth cycles, which is consistent with the results for PFSA/PFSA/PFSA MEAs and for HC/HC/HC MEAs. In addition, the durability results are comparable to those for PFSA/PFSA/PFSA MEAs and for HC/HC/HC MEAs. During the conditioning process, the difference between the last two cycles was less than 5 mV (or 50 mW/cm²), indicating that the cathode starvation process is efficient for conditioning HC/PFSA/HC MEAs.

By comparing the experimental data on different configurations of MEAs, namely, the HC/HC/HC, PFSA/HC/PFSA, and HC/PFSA/HC configurations for the anode catalyst binders, the PEM, and the cathode catalyst binders, respectively, several surprising results were found.

First, conventional standard conditioning processes, such as the amperometric, EU, and DOE conditioning processes, are effective in conditioning MEAs as long as the catalyst binders are PFSA-based, and the cathode starvation process is equally effective in terms of performance. The conditioning effectiveness is not affected by the material used for the PEM, whether it is PFSA-based or hydrocarbon-based. In other words, the type of membrane (PFSA vs. hydrocarbon) had little to no effect on the results of the conditioning processes. This is surprising given the lower chemical/electrochemical instability of hydrocarbons compared to PFSAs. The advantage of the cathode starvation conditioning process according to the embodiments of the present disclosure for MEAs with PFSA-based catalyst binders is mainly the significantly shortened conditioning time.

Second, conventional standard conditioning processes, such as the amperometric, EU, and DOE conditioning processes, are all ineffective and destructive in conditioning MEAs if the catalyst binders are hydrocarbon-based. This shows that conventional conditioning processes are not suitable for activating the type of MEAs with hydrocarbon-based catalyst binders. In comparison, the cathode starvation conditioning process according to the embodiments of the present disclosure has shown surprisingly good results in terms of initial performance and durability for MEAs with hydrocarbon-based catalyst binders, regardless of the material used for the PEM. The reduced conditioning time provided by the cathode starvation conditioning process according to the embodiments of the present disclosure is an additional advantage over conventional conditioning processes.

The use of the cathode starvation conditioning process for conditioning MEAs with hydrocarbon-based catalyst binders is surprising because, as shown by the experimental data, all conventional conditioning processes have failed to provide acceptable efficacy for this type of MEA. Moreover, the destructive results in the initial performance by the conventional conditioning processes may be perceived as if the MEAs with hydrocarbon-based catalyst binders were not suitable to be subjected to any conditioning process at all. Thus, the conditioning processes according to the embodiments of the present disclosure unexpectedly solve the above difficulties and are particularly advantageous for MEAs with hydrocarbon-based catalyst binders in the catalyst layers.

### Inert Gas Purging Conditioning Method

In addition to the oxygen cutoff conditioning method described above, another cathode starvation conditioning method according to the present disclosure is herein described, referred to as “inert gas purging”. The MEA utilized in this method may be identical to that described in the context of the cathode starvation conditioning method, shown in FIG. 1. During cathode starvation conditioning, the presence of residual oxygen prolongs the duration required to attain the cutoff voltage, thereby extending the conditioning period necessary to achieve the desired effect. To diminish the conditioning time while enhancing the conditioning impact on fuel cell performance, the inert gas purging conditioning method is implemented to expedite removal of the residual oxygen from the fuel cell during its conditioning.

Purging with inert gas not only facilitates more rapid removal of residual oxygen but also prevents the formation of potentially combustible fuel/oxygen mixtures at the cathode. Consequently, inert gas purging renders the conditioning process faster and more effective in certain scenarios, such as large-scale industrial and commercial fuel cell applications.

The inert gas atmosphere allows for the substitution of the current-based cathode-starvation oxygen cutoff conditioning cycle with a voltage-based conditioning cycle. Given that voltage-based parameters remain consistent irrespective of changes in the fuel cell's surface area-unlike current-based parameters, which vary with the active area—this adaptation enables the application of consistent conditioning parameters across fuel cells of varying active areas and capacities, and extends their applicability to a diverse range of applications.

An additional advantage of the inert gas purging conditioning method is its efficacy in removing impurities present at various fuel cell polarization levels. This is achieved by employing a voltage scan rather than a fixed value. The inert gas purging conditioning method is executed on a fuel cell comprising a MEA with at least one hydrocarbon-based ionomer catalyst layer. The method encompasses the following steps.

First, hydrogen is supplied to an anode side of the MEA and oxidant is supplied to a cathode side of the MEA. As such, a voltage is established across the MEA, representing the OCV. The OCV serves as a baseline measurement for the fuel cell's electrical potential in the absence of an external load.

Then, on the cathode side of the MEA, the oxidant is purged with an inert gas relative to hydrogen. This inert gas may include one or more common inert gases such as nitrogen, argon, or helium. In addition, a mixture of inert gas with hydrogen or oxygen is possible, such as combinations of hydrogen and nitrogen or oxygen and nitrogen. This substitution process, referred to as “purging”, involves supplying the inert gas to the cathode side of the MEA in place of the initially supplied oxidant, thus depriving the cathode side of any oxidant. As used herein, an “inert gas” is any gas that does not chemically react with hydrogen under the operating conditions of the fuel cell.

The method further includes applying a voltage scan profile across the MEA, the voltage scan profile beginning at the OCV and ending at a cycle end voltage lower than the OCV. The replacement of the oxidant with the inert gas may occur prior to or concurrent with the application of the voltage scan profile.

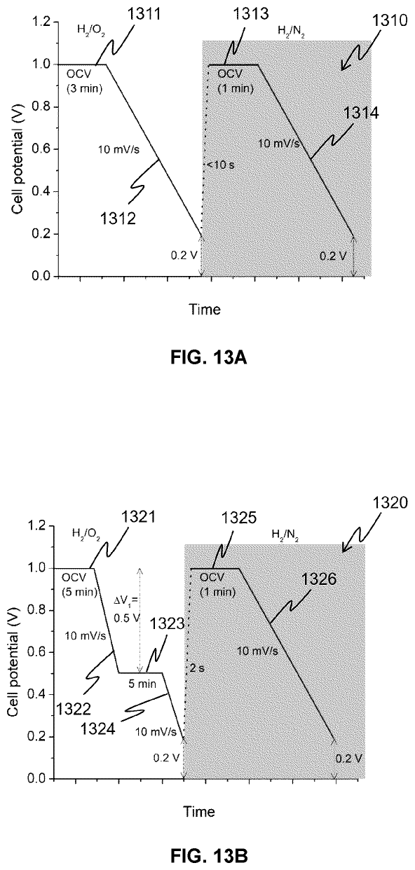

FIG. 12A shows an example voltage scan profile 1200 for the inert gas purging conditioning method. In the beginning, hydrogen is supplied to the anode side of the MEA and oxidant is supplied to the cathode side of the MEA. At 1201, a voltage across the MEA begins at the OCV at about 1.0 V in this example. It should be understood that another value for the OCV is also possible, depending on the configuration of the MEA and the fuel cell. The operation 1201 is maintained for an initial duration t₁, which may range from 1 second to 30 minutes.

At 1202, the voltage across the MEA is polarized to a first intermediate potential E₁ at a first decrease rate dV₁/dt₁. The first intermediate potential E₁ may be about 0.5 V, and the first decrease rate dV₁/dt₁ may range from 1 mV/s to 1 V/s. The first intermediate potential E₁ is lower than the OCV by a first differential ΔV₁, which may range from 1 mV to 1.2 V. Then, at 1203, the voltage is maintained at E₁ for a second duration t₂, which may range from 1 second to 30 minutes. At 1204, the voltage across the MEA is further polarized to a first cutoff voltage, which is higher than 0 V by a second differential ΔV₁, which may range from 1 mV to 1 V, at a second decrease rate dV₂/dt₂ ranging from 1 mV/s to 1 V/s. After 1204, an inert gas, such as nitrogen, is supplied to replace the oxidant.

After the inert gas has purged the oxidant, the voltage across the MEA is capable of returning to the OCV at a third rate dV₃/dt₃. At 1205, the voltage is maintained for a third duration t₃, which may range from 1 second to 30 minutes. At 1206, the voltage across the MEA is polarized to a second intermediate potential E₂ at a fourth decrease rate dV₄/dt₄. The second intermediate potential E₂ may be about 0.5 V, and the fourth decrease rate dV₄/dt₄ may range from 1 mV/s to 1 V/s. The second intermediate potential E₂ is lower than the OCV by a third differential ΔV₃, which may range from 1 mV to 1.2 V. Then, at 1207, the voltage is maintained at E₂ for a fourth duration t₄, which may range from 1 second to 30 minutes. At 1208, the voltage across the MEA is further polarized to a cycle end voltage, which is higher than 0 V by a fourth differential ΔV₄, which may range from 1 mV to 1 V, at a fifth decrease rate dV₅/dt₅ ranging from 1 mV/s to 1 V/s. The cycle end voltage is lower than the OCV.

Conditioning may be terminated after a single cycle or after a predetermined number of cycles. Alternatively, the termination of conditioning may be contingent upon the achievement of a specified criterion, namely, when a difference in power density between two successive cycles falls below a threshold value, for example, in the range of 20 to 30 mW/cm², such as 25 mW/cm². This criterion indicates that the fuel cell performance has reached a state of stabilization, beyond which additional conditioning is likely to yield diminishing returns.

The illustration in FIG. 12A represents merely one among numerous potential voltage scan profiles. The phase prior to the replacement of the oxidant serves as a mechanism for evaluating the efficacy of the conditioning process across cycles and determining the appropriate juncture for ceasing conditioning. Conversely, in certain configurations or contexts, such as industrial or commercial applications, the voltage scan preceding the replacement of the oxidant may be simplified to merely maintain the voltage at the OCV for the initial duration t₁, which may range from 1 second to 30 minutes. Such an alternative voltage scan profile 1210 is depicted in FIG. 12B, where the voltage scan subsequent to the oxidant replacement mirrors that of FIG. 12A. FIG. 12B also shows that the voltage scan profile may begin after the oxidant has been purged by the inert gas.

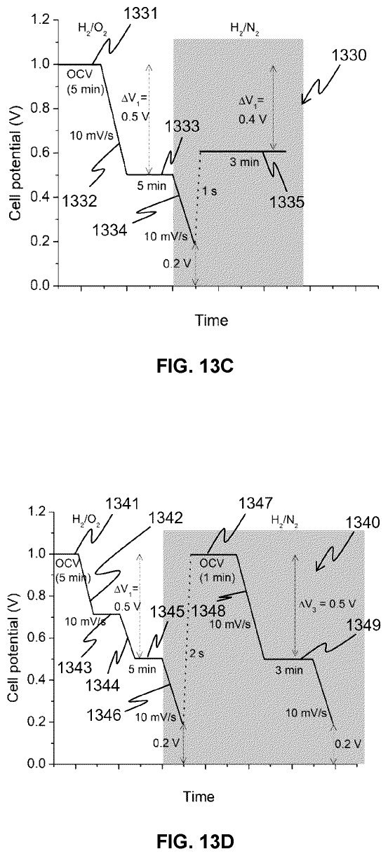

FIGS. 13A to 13F show a total of six different voltage scan profiles suitable for evaluating the efficacy of the conditioning process across cycles.

FIG. 13A illustrates a first variation of voltage scan profile 1310. Beginning at 1311, the oxidant is supplied to the cathode side of the MEA and the voltage across the MEA is maintained at the OCV (1.0 V in this example) for 3 minutes. At 1312, the voltage is decreased at a rate of 10 mV/s until it reaches 0.2 V. The oxidant is then purged by the inert gas and the voltage is allowed to return to the OCV in less than 10 seconds. At 1313, the voltage is held at the OCV for 1 minute, and at 1314, the voltage decreases at a rate of 10 mV/s until it reaches the cycle end voltage (0.2 V in this example) to complete the cycle.

FIG. 13B illustrates a second variation of the voltage scan profile 1320. Beginning at 1321, oxidant is supplied to the cathode side of the MEA and the voltage across the MEA is maintained at the OCV (1.0 V in this example) for 5 minutes. At 1322, the voltage decreases at a rate of 10 mV/s until it reaches 0.5 V. At 1323, the voltage is held at 0.5 V for 5 minutes before continuing to decrease at a rate of 10 mV/s to 0.2 V at 1324. The oxidant is then purged by the inert gas and the voltage is allowed to return to the OCV in 2 seconds. At 1325, the voltage is held at the OCV for 1 minute, and at 1326, the voltage decreases at a rate of 10 mV/s until it reaches the cycle end voltage (0.2 V in this example) to complete the cycle.

FIG. 13C illustrates a third variation of voltage scan profile 1330. Beginning at 1331, the oxidant is supplied to the cathode side of the MEA and the voltage across the MEA is maintained at the OCV (1.0 V in this example) for 5 minutes. At 1332, the voltage decreases at a rate of 10 mV/s until it reaches 0.5 V. At 1333, the voltage is held at 0.5 V for 5 minutes. The oxidant is then purged by the inert gas, and the voltage is further decreased at a rate of 10 mV/s to 0.2 V at 1334. The voltage is then allowed to return to 0.6 V in 1 second. At 1335, the voltage is held at 0.6 V for 3 minutes (0.6 V is the cycle end voltage in this example) to complete the cycle.

FIG. 13D illustrates a fourth variation of the voltage scan profile 1340. Beginning at 1341, oxidant is supplied to the cathode side of the MEA and the voltage across the MEA is maintained at the OCV (1.0 V in this example) for 5 minutes. At 1342, the voltage decreases at a rate of 10 mV/s until it reaches 0.7 V. At 1343, the voltage is held at 0.7 V for 5 minutes. At 1344, the voltage decreases again at a rate of 10 mV/s until it reaches 0.5 V. At 1345, the voltage is held at 0.5 V for 5 minutes. The oxidant is then purged by the inert gas, followed by a further decrease in voltage at a rate of 10 mV/s to 0.2 V at 1346. The voltage is then allowed to return to the OCV in 2 seconds. At 1347, the voltage is held at the OCV for 1 minute, followed by the voltage decreasing at a rate of 10 mV/s at 1348 until it reaches 0.5 V. The voltage is then held at 1349 for 3 minutes before continuing to decrease at a rate of 10 mV/s until it reaches the cycle end voltage (0.2 V in this example) to complete the cycle.

FIG. 13E illustrates a fifth variation of voltage scan profile 1350. Beginning at 1351, the oxidant is supplied to the cathode side of the MEA and the voltage across the MEA is maintained at the OCV (1.0 V in this example) for 1 minute. At 1352, the voltage decreases at a rate of 10 mV/s until it reaches 0.5 V. At 1333, the voltage is held at 0.5 V for 3 minutes. The oxidant is purged by the inert gas, and the voltage is then allowed to return to the OCV in 2 seconds. At 1354, the voltage is held at the OCV for 1 minute, followed by the voltage decreasing at a rate of 10 mV/s at 1355 until it reaches 0.5 V. The voltage is then held at 1356 for 3 minutes before continuing at 1357 to decrease at a rate of 10 mV/s until it reaches the cycle end voltage (0.1 V in this example) to complete the cycle.

FIG. 13F illustrates a sixth variation of voltage scan profile 1360. Beginning at 1361, the oxidant is supplied to the cathode side of the MEA and the voltage across the MEA is maintained at the OCV (1.0 V in this example) for 5 minutes. At 1362, the voltage decreases at a rate of 10 mV/s until it reaches 0.5 V. At 1363, the voltage is held at 0.5 V for 5 minutes. The oxidant is then purged by the inert gas, and the voltage is further decreased at a rate of 10 mV/s to 0.2 V at 1364. The voltage is then allowed to return to the OCV in 2 seconds. At 1365, the voltage is held at the OCV for 1 minute, followed by the voltage decreasing at a rate of 10 mV/s at 1366 until it reaches 0.5 V. The voltage is then held at 1367 for 3 minutes before continuing at 1368 to decrease at a rate of 10 mV/s until it reaches the cycle end voltage (0.2 V in this example) to complete the cycle.

For the variations of the voltage scan shown in any one of FIGS. 13A to 13F, each cycle ends at the cycle end voltage, and the voltage scan may be repeated until a predetermined condition is met, such as the difference in power density measured when the cathode is supplied with the oxidant being less than a threshold value between two successive cycles. The voltage scan may also be repeated a predetermined number of times without comparing the difference in power density, and thus it is not necessary to perform the voltage scan while the cathode side is supplied with the oxidant, and the voltage may simply be maintained at the OCV for some time (e.g., to stabilize the voltage) before the oxidant is purged by the inert gas on the cathode side, as shown in FIG. 12B.

It should be noted that the values depicted in FIGS. 13A to 13F are only example, illustrative values. These values may be modified as required, depending on the specific properties, configurations, or environmental conditions involved. It should also be noted that in FIGS. 12A, 12B, and 13A through 13F, the horizontal axis represents time, yet it is not depicted with specific units. This absence of unit representation is intentional, as these figures are designed to illustrate example voltage scan profiles suitable for a variety of different situations rather than to provide precise plot details.

Experimental setups, measurements, results, and observations are described in detail below to demonstrate various advantages of the conditioning process according to the embodiments of the present disclosure. Certain materials and parameters were selected in the experiments because of their availability, but the present disclosure should not be limited to these materials and parameters, and it should be appreciated that any variations in the selection of materials and parameters that are within reasonable considerations could lead to similar results.

### Experiments (Inert Gas Purging Conditioning)

Experiments were conducted to test the inert gas purging_conditioning method on an MEA of a PEMFC and the use of a PEMFC conditioned by the conditioning method.

### 4. MEA with an HC/HC/HC Configuration

### 4.1 MEA Preparation

MEA preparation steps, chemicals/materials, instruments to make catalyst ink and deposition were kept the same as those discussed in Section 1.1. PEMFC assembly materials, parameters, test station instruments were also kept the same as what is discussed in Section 1.1.

### 4.2 Conditioning

The conditioning was performed at ambient pressure and without back pressure for the inert gas purging conditioning. However, it should be appreciated that the inert gas purging conditioning may also be subject to back pressure.

The conditioning cycle is shown in Table 2. The switch from oxygen to nitrogen was performed manually. However, it should be appreciated that automated operation is also possible, and inert gases other than nitrogen may be additionally included or substituted.

TABLE 2
A representative cycle of potential controlled reactant starvation
for the conditioning of fuel cells via N₂ purging

| | Steps | Fuel |
|---|---|---|
| 1. | Polarize the fuel cell from OCV (~1 V) to 0.5 V at the scan | H₂/O₂ |
| | rate of 10 mV/s | |
| 2. | Maintain at 0.5 V until stabilized | H₂/O₂ |
| 3. | Switch cathode feed gas from O₂ to N₂ | |
| 4. | Polarize the fuel cell from 0.5 V to 0.2 V at the scan rate of | H₂/N₂ |
| | 10 mV/s | |
| 5. | Allow the voltage to be returned to OCV (~1 V) | H₂/N₂ |
| 6. | Polarize the fuel cell from OCV (~1 V) to 0.5 V at the scan | H₂/N₂ |
| | rate of 10 mV/s | |
| 7. | Maintain at 0.5 V until stabilized | H₂/N₂ |
| 8. | Polarize the fuel cell from 0.5 V to 0.2 V at the scan rate of | H₂/N₂ |
| | 10 mV/s | |
| 9. | Turn on the cathode feed gas and repeat the cycle until the | |
| | difference in power density between cycles is less than | |
| | cut-off value i.e., <25 mW/cm² in this example | |

Since cathode starvation conditioning based on oxygen cutoff has already been established as superior to the conventional conditioning methods (such as the amperometric process, the EU process, and the DOE process), the proposed nitrogen purging conditioning method was compared only with the oxygen cutoff conditioning method.

The conditioning configurations and parameters used in the experimentation are described below as a series of steps:
a) During the test, the inlet gas flows were set at 0.5 standard liter per minute (slpm) hydrogen at the anode side and 1.0 slpm oxygen at the cathode side, and the fuel cell temperature was set at 80° C., 100% RH at both electrodes, ambient anode and cathode backpressure.
b) The fuel cell was first held at open circuit voltage (OCV) for 1 minute at a scan interval of 1 second per point.
c) The fuel cell voltage was then ramped from OCV to 0.5 V at a scan interval of 0.2 second per point and 2 mV per point. The fuel cell voltage may be adjusted by connecting a load to the fuel cell.
d) After reaching 0.5 V, the fuel cell was held at this constant voltage for 3 minutes.
e) After stabilizing at 0.5 V, the cathode gas flow rate was switched from oxygen to nitrogen. This depletes the oxygen thus “starving” the cathode.
f) The fuel cell voltage was then ramped from 0.5 V to 0.2 V at a scan interval of 0.2 second per point and 2 mV per point.
g) The fuel cell voltage was allowed to be returned to OCV by terminating the voltage scan. For example, it may be implemented by removing the external load or current drawn from the fuel cell.
h) The fuel cell was subsequently ramped from OCV to 0.5 V at a scan interval of 0.2 second per point and 2 mV per point.
i) After reaching 0.5 V, the fuel cell was held at this constant voltage for 3 minutes.
j) The fuel cell voltage was then ramped from 0.5 V to 0.2 V at a scan interval of 0.2 second per point and 2 mV per point. Although there is a risk of irreversible damage to the MEAs occurring at potential below 0.2 V, it was found that quick ramping to 0.2 V for a short duration is acceptable.
k) After reaching the cut-off voltage, the cathode feed gas was switched from nitrogen to oxygen and the cycle was repeated until the difference in power density measured at 0.5 V under hydrogen and oxygen was <25 mW/cm².

### 4.3 Measurements and Performance

Prior to measurement, the cell was equilibrated at OCV. Polarization and power curve analyses were performed to determine the current-voltage relationship as a measure of the performance of the MEA. EIS analyses were performed to examine various aspects of performance, including charge transfer resistance and MEA resistance, etc. For each figure and curve, the best-in-class data from the 3 samples tested have been reported. Where appropriate, error bars have been inserted to indicate the associated standard deviation.

For the polarization and power curve analyses, the fuel cell was operated at 80° C., ambient pressure, and 100% RH with inlet gas flows of 0.5 slpm hydrogen on the anode side and 1.0 slpm oxygen on the cathode side. After conditioning and equilibration, polarization curves were recorded from OCV to a cutoff potential of 0.3 V over 200 mA steps, measured at a scan interval of 5 minutes per point. The resolution of the kinetic region was determined by current scanning from 0.00 to 0.20 A over 0.01 A steps at a scan interval of 1 minute per point. Similarly, the ohmic region was scanned from 0.50 A to 1.50 A with 0.50 A steps at a scan interval of 5 minutes per point. Finally, the mass transfer region of the polarization curve was obtained by scanning from 2 A to 15 A using 1 A steps at a scan interval of 5 minutes per point.

The EIS analysis was performed on fuel cells equilibrated under 0.5 slpm H₂ on the anode side and 1 slpm O₂; an AC voltage amplitude of 10 mV was applied and frequency scans were performed from 100 KHz to 10 mHz. EIS characterization was then performed potentiostatically at 0.8 V. A Randle's equivalent circuit model was used to extract meaningful information from the obtained EIS data by modeling the different regions of the fuel cell as an electrical circuit. The corresponding impedance data were then plotted in a Nyquist plot and fitted in Zview™ software using a simple Randles circuit.

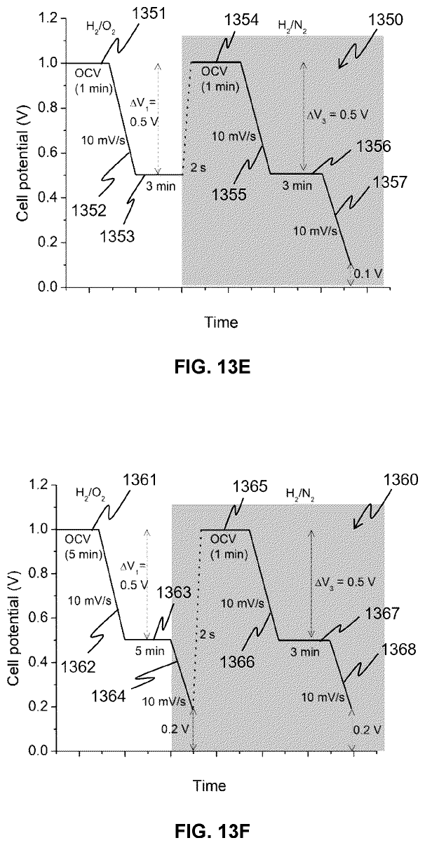

The newly assembled fuel cell was subjected to the cathode starvation (through nitrogen purging) conditioning cycles described in Table 2. The potential profile of the fuel cell during conditioning is shown in FIG. 14A. A total of four complete cathode starvation cycles (one cycle being the completion of all the steps listed in Table 2) were performed, and the time required to complete them was approximately 35 minutes. Not only was this fast conditioning achieved, but also an increase of approximately 400 mW/cm² was achieved from the initial to the final cycle (FIG. 14B), an improvement of 30%. This is higher than what can be achieved by cathode starvation via oxygen cutoff.

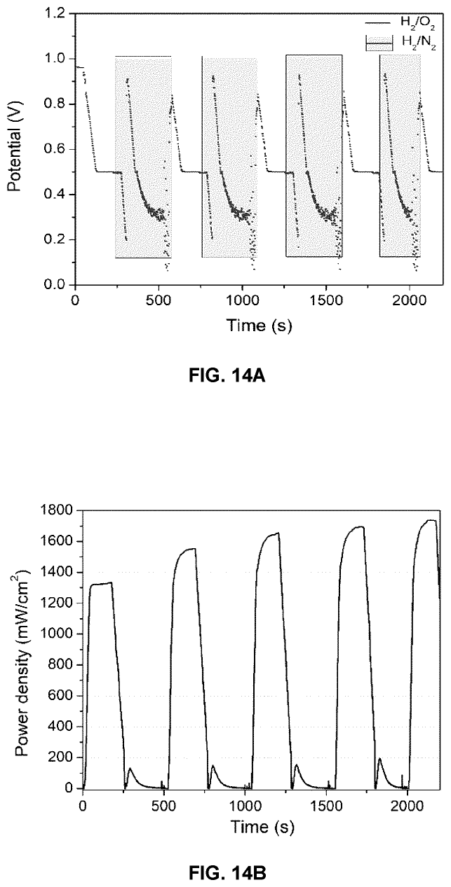

To further understand the effect of cathode starvation (through nitrogen purging) on fuel cells, EIS measurements were performed at the potentials of 0.8 V before and after conditioning as shown in FIG. 15. It is clear from the data that both the ionic resistance and the polarization resistance of the assembled fuel cell were significantly lower after cathode starvation (through nitrogen purging) conditioning. It is concluded that this significant reduction in resistance values directly corresponds to improved fuel cell performance.

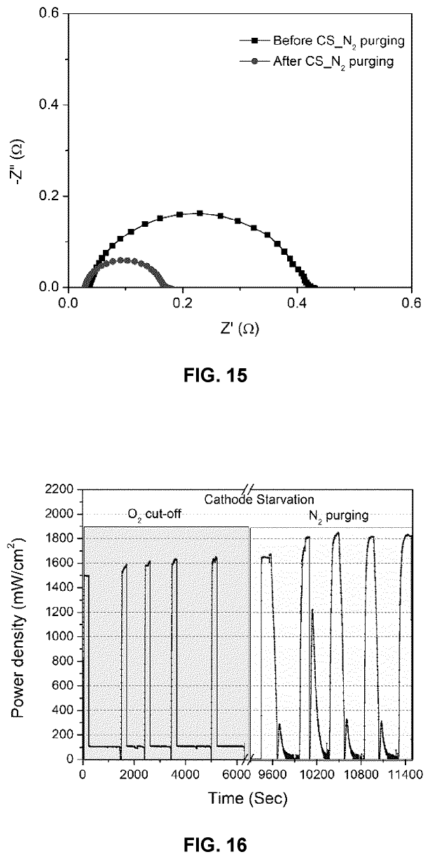

FIG. 16 shows a plot of the cathode starvation conditioning profiles of the oxygen cutoff and nitrogen purging conditioning processes discussed above for an HC/HC/HC MEA. In this experiment, sPPB-H⁺ ionomers were used for both the PEM and the catalyst binder. In the cathode starvation process shown in FIG. 16, the HC/HC/HC MEAs were subjected to five conditioning cycles, with the peak power density increasing with the number of conditioning cycles. An increase in the peak power density was observed from the first (1,510 mW/cm²) to the fifth (1,630 mW/cm²) cycle, with the performance stabilizing between the fourth and fifth cycles, indicating a relatively short conditioning time. After a stable power density was obtained from the oxygen cutoff conditioning method, the nitrogen purging conditioning method was applied. Surprisingly, the power density of the fuel cell was further improved by another 200 mW/cm² to 1,820 mW/cm². After five conditioning cycles the increment in power density between the first and last cycle was approximately 220 mW/cm² for the oxygen cutoff conditioning and approximately 340 mW/cm² for the nitrogen purging conditioning. This shows that the nitrogen purging method is more effective in conditioning the fuel cells.

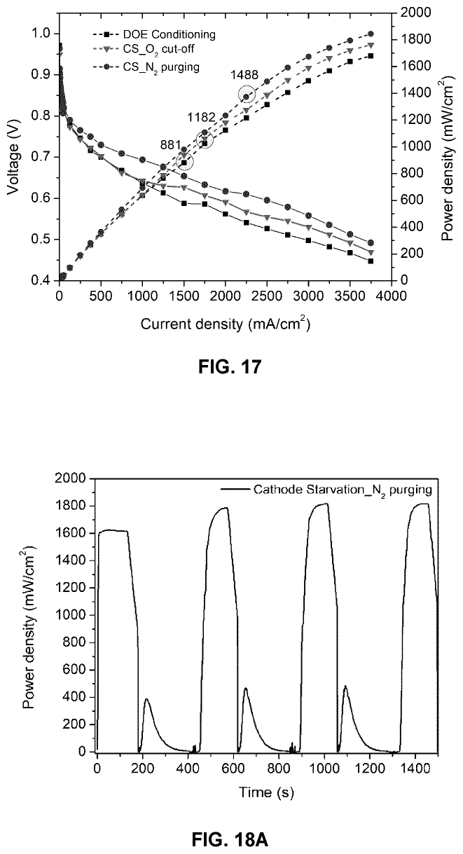

FIG. 17 shows the performance plots of HC/HC/HC MEAs subjected to the cathode starvation conditioning processes under conditions of 80° C., 100% RH and 1 atm pressure: I-V polarization and power curves immediately after conditioning and peak power density at 0.6 V. The graph shows the performance plots of fuel cells after conditioning by the DOE standard methods for one hour, cathode starvation by oxygen cutoff conditioning and cathode starvation by nitrogen purging conditioning. The peak power density values of the PEMFC were improved from 1,690 mW/cm² to 1,782 and 1,844 mW/cm² for the oxygen cutoff conditioning and nitrogen purge conditioning, respectively.

The encircled portions in FIG. 17 correspond to the power density values at 0.6 V, a common metric used to compare different fuel cell performances. They show that, compared to the power density achieved by DOE conditioning (881 mW/cm²), cathode starvation by oxygen cutoff conditioning (1,182 mW/cm²) and nitrogen purging conditioning (1,488 mW/cm²) are 34.1% and 68.8% higher, respectively, indicating the effectiveness of conditioning.

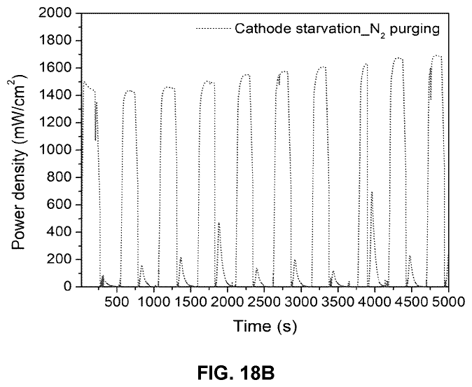

FIGS. 18A and 18B show the nitrogen purging conditioning process of two HC membranes, each subjected to different initial conditions. The HC membrane shown in FIG. 18A required approximately 25 minutes for conditioning, whereas the HC membrane shown in FIG. 18B from another batch required approximately 75 minutes to reach full conditioning, evidenced by the power density between successive cycles falling below a specified threshold. This variation in conditioning times underscores the influence of initial membrane conditions, such as synthesis method, impurity levels, and reinforcement material types. It can be seen that the conditioning time can vary depending on the initial conditions of the membrane, but different membranes may exhibit a significant improvement in conditioning time compared with conventional conditioning methods, regardless of the initial conditions.

It has been demonstrated that it is possible to condition the HC/HC/HC MEA configuration using the nitrogen purging conditioning method. The conditioning time varies with the initial membrane condition and the impurities present, but it is possible to condition the membrane in as little as 30 minutes by adjusting the conditioning cycles and parameters. An increase in peak power density values of 300-400 mW/cm² has been achieved using nitrogen purging conditioning cycles.

As a variant of cathode starvation conditioning, the nitrogen purging method can also be applied to other MEA configurations, such as the PFSA/HC/PFSA configuration and the HC/PFSA/HC configuration that has been studied for oxygen cutoff based conditioning. Demonstrations have confirmed the efficacy of the oxygen cutoff conditioning method for these configurations within an oxygen-depleted environment. Utilizing inert gas to expedite the removal of residual oxygen, this approach is designed not to disrupt any electrochemical processes occurring during conditioning but to facilitate the efficient extraction of oxygen from the fuel cell. Further, it has been established that conditioning the fuel cell by reducing the voltage below a threshold level is achievable through a controlled voltage scan. Therefore, it is expected that the inert gas purging method, similar to cathode starvation by oxygen cutoff, will be compatible with all other MEA configurations.

It is contemplated that any part of any aspect or embodiment discussed in this specification may be implemented or combined with any part of any other aspect or embodiment discussed in this specification.

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without operator input or prompting, whether these features, elements and/or steps are included or are to be performed in any particular embodiment. No single feature or group of features is required for or indispensable to any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

The example calculations, simulations, results, graphs, values, and parameters of the embodiments described herein are intended to illustrate and not to limit the disclosed embodiments. Other embodiments can be configured and/or operated differently than the illustrative examples described herein. Indeed, the novel methods and apparatus described herein may be embodied in a variety of other forms; furthermore, various omissions, substitutions and changes in the form of the methods and systems described herein may be made without departing from the spirit of the inventions disclosed herein. It will be apparent to those skilled in the art that modifications and adaptations of the foregoing embodiments not shown are possible.

1. A method for conditioning a fuel cell comprising a membrane electrode assembly (MEA) with at least one hydrocarbon-based ionomer catalyst layer, the method comprising:
supplying hydrogen to an anode side of the MEA and oxidant to a cathode side of the MEA;
purging the oxidant supplied to the cathode side of the MEA with an inert gas, wherein the inert gas is chemically inert relative to hydrogen; and
applying a voltage scan profile across the MEA beginning at an open circuit voltage (OCV) of the MEA and ending at a cycle end voltage lower than the OCV.

2. The method as claimed in claim 1, wherein the MEA comprises a proton exchange membrane composed of hydrocarbon-based or perfluorosulfonic acid (PFSA) material.

3. The method of claim 1 or 2, wherein the applying is performed after the inert gas has purged the oxidant.

4. The method of claim 1 or 2, wherein the replacement of the oxidant with the inert gas is performed during the applying.

5. The method of any one of claims 1 to 3, wherein the voltage scan profile begins by maintaining the voltage across the MEA at the OCV for an initial duration.

6. The method as claimed in claim 5, wherein the initial duration ranges from 1 second to 30 minutes.

7. The method of any one of claims 1 to 6, wherein the voltage scan profile comprises a voltage decrease duration in which the voltage across the MEA decreases at a rate ranging from 1 mV/s to 1 V/s.

8. The method of claim 7, wherein the voltage decrease duration is performed after the oxidant has been purged by the inert gas.

9. The method of any one of claims 1 to 8, wherein the cycle end voltage is between 1 mV and 1 V.

10. The method any one of claims 1 to 9, further comprising resupplying the oxidant to the cathode side after reaching the cycle end voltage.

11. The method of claim 10, further comprising repeating the replacing, applying, and resupplying for a plurality of cycles until a difference in power density between two successive cycles is less than a cutoff value.

12. The method of claim 11, wherein the cutoff value ranges from 20 to 30 mW/cm².

13. The method of any one of claims 10 to 12, further comprising repeating the replacing, applying, and resupplying for a predetermined number of cycles.

14. The method of any one of claims 1 to 13, wherein the hydrogen is supplied at 0.1 to 5.0 standard liters per minute (SLPM) on the anode side of the MEA and the oxidant is supplied at 0.1 to 5.0 SLPM on the cathode side of the MEA.

15. The method of any one of claims 1 to 14, wherein the fuel cell is conditioned at a temperature of 60 to 90° C. and a relative humidity at 70% to 100% on the anode and cathode sides of the MEA.

16. The method of any one of claims 1 to 15, wherein the inert gas comprises at least one of nitrogen, argon, or helium.

17. A method for conditioning a fuel cell comprising a membrane electrode assembly (MEA) with at least one hydrocarbon-based ionomer catalyst layer, the method comprising:
supplying hydrogen to an anode side of the MEA and oxidant to a cathode side of the MEA;
adjusting a voltage across the MEA from an open circuit voltage (OCV) to a first voltage and maintaining the first voltage for a selected first duration; and
reducing the oxidant supplied to the cathode side of the MEA while maintaining a constant current until either a cutoff duration or a cutoff voltage is met.

18. The method of claim 17, wherein the MEA comprises a proton exchange membrane composed of hydrocarbon-based or perfluorosulfonic acid (PFSA) material.

19. The method of claim 17 or 18 further comprising, prior to the adjusting, increasing a back pressure on the anode side of the MEA to a first pressure level and maintaining a back pressure on the cathode side of the MEA at an ambient pressure, wherein the first pressure is larger than the ambient pressure.

20. The method of any one of claims 17 to 19 further comprising, prior to the adjusting, holding the voltage across the MEA at the OCV for a selected second duration.

21. The method of any one of claims 17 to 20 further comprising repeating the adjusting and the reducing for a plurality of cycles until a voltage difference between a voltage response on a load after the selected first duration of a current cycle and the voltage response on the load after the selected first duration of a previous cycle is less than a voltage threshold.

22. The method of claim 19, wherein the first pressure level ranges from 22 to 44 psi.

23. The method of any one of claims 17 to 22, wherein the first voltage ranges from 0.3 to 0.8 V.

24. The method of any one of claims 17 to 23, wherein the constant current ranges from 0.2 to 10.0 A.

25. The method of claim 20, wherein the selected second duration ranges from 1 to 15 minutes.

26. The method of any one of claims 17 to 25, wherein the selected first duration ranges from 3 to 30 minutes.

27. The method of any one of claims 17 to 26 wherein the cutoff voltage ranges from 0.1 to 0.5 V.

28. The method of claim 21, wherein the voltage threshold ranges from 2 to 20 mV.

29. The method of any one of claims 17 to 28, wherein the hydrogen is supplied at 0.1 to 5.0 standard liters per minute (SLPM) on the anode side of the MEA and the oxidant is supplied at 0.1 to 5.0 SLPM on the cathode side of the MEA.

30. The method of any one of claims 17 to 29, wherein the fuel cell is conditioned at a temperature of 60 to 90° C. and a relative humidity at 70% to 100% on the anode and cathode sides of the MEA.

31. Use of the method of any one of claims 1 to 30 for conditioning a fuel cell having a membrane electrode assembly (MEA), wherein the MEA comprises a hydrocarbon-based ionomer catalyst layer.

32. A proton exchange membrane fuel cell comprising a membrane electrode assembly (MEA) with at least one hydrocarbon-based ionomer catalyst layer, wherein the fuel cell is conditioned by the method of any one of claims 1 to 30.
